(19) United States
(12) Patent Application Publication
(10) Pub. No.: US 2024/0283613 A1
(43) Pub. Date: Aug. 22, 2024

(54) ACCESS POINT AND WIRELESS COMMUNICATION METHOD

(71) Applicant: GUANGDONG OPPO MOBILE TELECOMMUNICATIONS CORP., LTD., Dongguan (CN)

(72) Inventor: Lei HUANG, Singapore (SG)

(21) Appl. No.: 18/651,097

(22) Filed: Apr. 30, 2024

Related U.S. Application Data
(63) Continuation of application No. PCT/CN2021/129146, filed on Nov. 5, 2021.

(51) Int. Cl. H04L 5/00

(52) U.S. Cl. CPC H04L 5/0053; H04L 5/0023; H04L 5/0035; H04L 5/0094

(57) ABSTRACT

Provided is a wireless communication method by an access point (AP). The AP can be a sharing AP. The wireless communication method includes transmitting, by the sharing AP, a trigger frame to one or more shared APs to solicit extremely high throughput (EHT) multi-user (MU) physical layer protocol data unit (PPDU) transmissions from the one or more shared APs in a multi-AP coordinated downlink (DL) transmission. The trigger frame comprises an EHT variant common information field, a special user information field, and one or more EHT variant user information fields. A DL bandwidth (BW) subfield of the EHT variant common information field along with a DL BW extension subfield of the special user information field indicates a coordinated transmission BW for the multi-AP coordinated DL transmission.

### CROSS-REFERENCE TO RELATED APPLICATION

This application is a continuation of International Application No. PCT/CN2021/129146, filed Nov. 5, 2021, the entire disclosure of which is incorporated herein by reference.

### TECHNICAL FIELD

The present disclosure relates to the field of communication systems, and more particularly, to an access point (AP) and a wireless communication method, which can provide a good communication performance and/or provide high reliability.

### BACKGROUND

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as, time, frequency, and power). A wireless network, for example a wireless local area network (WLAN), such as a Wi-Fi (institute of electrical and electronics engineers (IEEE) 802.11) network may include an access point (AP) that may communicate with one or more stations (STAs) or mobile devices. The WLAN enables a user to wirelessly access an internet based on radio frequency technology in a home, an office, or a specific service area using a portable terminal such as a personal digital assistant (PDA), a laptop computer, a portable multimedia player (PMP), a smartphone, etc. The AP may be coupled to a network, such as the internet, and may enable a mobile device to communicate via the network (or communicate with other devices coupled to the AP). A wireless device may communicate with a network device bi-directionally. For example, in a WLAN, a STA may communicate with an associated AP via downlink and uplink. The downlink may refer to a communication link from the AP to the STA, and the uplink may refer to a communication link from the STA to the AP.

### SUMMARY

According to some embodiments of the present disclosure, a wireless communication method by an access point (AP) is provided. The method includes transmitting, by the AP as a sharing AP to one or more shared APs, a trigger frame to solicit extremely high throughput (EHT) multi-user (MU) physical layer protocol data unit (PPDU) transmissions from the one or more shared APs in a multi-AP coordinated downlink (DL) transmission, wherein the trigger frame includes a EHT variant common information field, a special user information field, and one or more EHT variant user information fields, and a DL bandwidth (BW) subfield of the EHT variant common information field along with a DL BW extension subfield of the special user information field indicates a coordinated transmission BW for the multi-AP coordinated DL transmission.

According to some embodiments of the present disclosure, a wireless communication method by an access point (AP) is provided. The method includes receiving, by the AP as a shared AP, from another AP as a sharing AP, a trigger frame which is used to solicit extremely high throughput (EHT) multi-user (MU) physical layer protocol data unit (PPDU) transmissions from one or more shared APs including the AP in a multi-AP coordinated downlink (DL) transmission, wherein the trigger frame includes a EHT variant common information field, a special user information field, and one or more EHT variant user information fields, and a DL bandwidth (BW) subfield of the EHT variant common information field along with a DL BW extension subfield of the special user information field indicates a coordinated transmission BW for the multi-AP coordinated DL transmission.

According to some embodiments of the present disclosure, an access point (AP) includes a memory, a transceiver, and a processor coupled to the memory and the transceiver. The processor is configured to perform the above method.

According to some embodiments of the present disclosure, a non-transitory machine-readable storage medium has stored thereon instructions that, when executed by a computer, cause the computer to perform the above method.

According to some embodiments of the present disclosure, a chip includes a processor, configured to call and run a computer program stored in a memory, to cause a device in which the chip is installed to execute the above method.

According to some embodiments of the present disclosure, a non-transitory computer readable storage medium, in which a computer program is stored, causes a computer to execute the above method.

According to some embodiments of the present disclosure, a computer program product includes a computer program, and the computer program causes a computer to execute the above method.

According to some embodiments of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic diagram illustrating an example AP candidate set which includes APs according to some embodiment of the present disclosure;

FIG. 1B is a schematic diagram illustrating an example multi-AP DL joint transmission according to some embodiment of the present disclosure;

FIG. 2A is a schematic diagram illustrating a bandwidth allocation for multiple EHT MU PPDU sets according to some embodiment of the present disclosure;

FIG. 2B is a schematic diagram illustrating a bandwidth allocation for multiple EHT MU PPDU sets according to some embodiment of the present disclosure;

FIG. 2C is a schematic diagram illustrating a bandwidth allocation for multiple EHT MU PPDU sets according to some embodiment of the present disclosure;

FIG. 2D is a schematic diagram illustrating a bandwidth allocation for multiple EHT MU PPDU sets according to some embodiment of the present disclosure;

FIG. 2E is a schematic diagram illustrating a bandwidth allocation for multiple EHT MU PPDU sets according to some embodiment of the present disclosure;

FIG. 3 is a schematic diagram illustrating an EHT MU PPDU format according to some embodiment of the present disclosure;

FIG. 4 is a schematic diagram illustrating an example multi-AP coordinated DL transmission according to some embodiment of the present disclosure;

FIG. 5 is a schematic diagram illustrating an example format of multi-AP coordinated transmission trigger frame format according to some embodiment of the present disclosure;

FIG. 6 is a schematic diagram illustrating an example format of the EHT variant common information field according to some embodiment of the present disclosure;

FIG. 7A is a schematic diagram illustrating an example format of special user information field of a multi-AP coordinated transmission trigger frame according to some embodiment of the present disclosure;

FIG. 7B is a schematic diagram illustrating an example format of a trigger dependent common information subfield according to some embodiment of the present disclosure;

FIG. 7C is a schematic diagram illustrating an example format of a punctured channel information subfield according to some embodiment of the present disclosure;

FIG. 7D is a schematic diagram illustrating an example format of a punctured channel information subfield according to some embodiment of the present disclosure;

FIG. 8A is a schematic diagram illustrating an example format of a special user information field according to some embodiment of the present disclosure;

FIG. 8B is a schematic diagram illustrating an example format of a trigger dependent user information subfield of a special user information field according to some embodiment of the present disclosure;

FIG. 8C is a schematic diagram illustrating an example format of a punctured channel information subfield according to some embodiment of the present disclosure;

FIG. 8D is a schematic diagram illustrating an example format of a punctured channel information subfield according to some embodiment of the present disclosure;

FIG. 9A is a schematic diagram illustrating an example format of EHT variant user information field according to some embodiment of the present disclosure;

FIG. 9B is a schematic diagram illustrating an example format of a trigger dependent user information field according to some embodiment of the present disclosure;

FIG. 10A is a schematic diagram illustrating an example format of EHT variant user information field according to some embodiment of the present disclosure;

FIG. 10B is a schematic diagram illustrating an example format of a trigger dependent user information field according to some embodiment of the present disclosure;

FIG. 11 is a schematic diagram illustrating an example of a wireless communications system according to some embodiment of the present disclosure;

FIG. 12 is a schematic diagram illustrating an example of a wireless communications system according to another embodiment of the present disclosure;

FIG. 13 is a schematic diagram illustrating an example of a wireless communications system according to another embodiment of the present disclosure;

FIG. 14 is a block diagram of one or more stations (STAs) and access points (APs) of communication in a wireless communications system according to some embodiment of the present disclosure;

FIG. 15 is a flowchart illustrating a wireless communication method performed by an AP according to some embodiment of the present disclosure;

FIG. 16 is a flowchart illustrating a wireless communication method performed by an AP according to another embodiment of the present disclosure;

FIG. 17 is a block diagram of an access point (AP) according to some embodiment of the present disclosure;

FIG. 18 is a block diagram of an access point (AP) according to some embodiment of the present disclosure; and

FIG. 19 is a block diagram of a system for wireless communication according to some embodiment of the present disclosure.

### DETAILED DESCRIPTION OF EMBODIMENTS

IEEE 802.11 TGbe is developing a new IEEE 802.11 amendment which defines extremely high throughput (EHT) physical layer (PHY) and medium access control (MAC) layers capable of supporting a maximum throughput of at least 30 Gbps. To this end, it has been proposed to increase maximum channel bandwidth to 320 MHz and increase maximum number of spatial streams to 16. In addition, it has been proposed to enable multi-AP coordination in a multi-AP system in order to improve system throughput. Example multi-AP coordination schemes include multi-AP coordinated downlink (DL) orthogonal frequency division multiple access (OFDMA) and multi-AP coordinated DL multi-user multiple input multiple output (MU-MIMO), etc. The multi-AP coordinated DL MU-MIMO may also be called multi-AP DL distributed MIMO or multi-AP DL joint transmission. However, it is still an open issue to efficiently implement multi-AP DL coordination in a multi-AP system.

Therefore, there is a need for an access point (AP) and a wireless communication method, which can solve issues in the prior art, efficiently implement multi-AP downlink (DL) coordination in a multi-AP system, achieve extremely high throughput, provide good communication performance, and/or provide high reliability.

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

TABLE 1

| Abbreviation | Full name |
|---|---|
| IEEE | Institute of Electrical and |
| | Electronics Engineers |
| WLAN | Wireless local area network |
| BSS | Basic service set |
| BSSID | BSS identifier |
| VBSS | Virtual BSS |
| VBSSID | VBSS identifier |
| AP | Access point |
| STA | Station |
| PHY | Physical layer |
| MAC | Medium access control |
| MPDU | MAC protocol data unit |
| PSDU | Physical layer service data unit |
| PPDU | Physical layer protocol data unit |
| A-PPDU | Frequency domain aggregated PPDU |
| HT | High throughput |
| HE | High efficiency |
| EHT | Extremely high throughput |
| MU | Multi-user |
| OFDMA | Orthogonal frequency division |
| | multiple access |
| L-LTF | Non-HT Long Training field |
| L-STF | Non-HT Short Training field |
| L-SIG | Non-HT SIGNAL field |
| RL-SIG | Repeated L-SIG |
| U-SIG | Universal SIGNAL field |
| EHT-STF | EHT Short Training field |
| EHT-LTF | EHT Long Training field |
| PE | Packet Extension field |
| BW | Bandwidth |
| GI | Guard interval |
| RU | Resource unit |
| MRU | Multiple resource unit |
| FEC | Forward error coding |
| TXOP | Transmission opportunity |
| MIMO | Multiple input multiple output |
| MIB | Management information base |
| MAPC | Multi-AP coordination |
| MLD | Multi-link device |
| SME | Station management entity |
| AID | Association identifier |
| VAID | Virtual AID |
| FEC | Forward error correction |
| BCC | Binary convolutional code |
| LDPC | Low density parity code |
| NAV | Network allocation vector |
| ED | Energy detect |
| DL | Downlink |
| UL | Uplink |
| MCS | Modulation and coding scheme |

AP refers to a standalone AP or an AP affiliated with an AP MLD; and STA refers to a standalone non-AP STA or an STA affiliated with a non-AP MLD. dot11EHTBaseLineFeaturesImplementedOnly and dot11Multi-APCoordinationOptionImplemented are two of MIB variables maintained by an STA's (or an AP's) SME. STA (or AP) with dot11EHTBaseLineFeaturesImplementedOnly equal to true refers to an EHT STA (or an EHT AP) that supports one or more EHT baseline features such as MRU and multi-link operation which have been defined in IEEE 802.11be D1.2; but does not support any EHT advanced features such as multi-AP coordination which will be defined in a later draft of IEEE 802.11be (e.g. IEEE 802.11be D3.0), i.e. WiFi7 R1 STA (or AP). STA (or AP) with dot11EHTBaseLineFeaturesImplementedOnly equal to false refers to an EHT STA (or an EHT AP) that support one or more EHT baseline features which have been defined in IEEE 802.11be D1.2 and one or more EHT advanced features which will be defined in a later draft of IEEE 802.11be (e.g., IEEE 802.11be D3.0), i.e., WiFi7 R2 STA (or AP). STA (or AP) with dot11Multi-APCoordinationOptionImplemented equal to true refers to an EHT STA (or an EHT AP) that supports multi-AP coordination; STA with and (or AP) dot11Multi-APCoordinationOptionImplemented equal to false refers to an EHT STA (or an EHT AP) that does not support multi-AP coordination. STA (or AP) with dot11EHTBaseLineFeaturesImplementedOnly equal to false and dot11Multi-APCoordinationOptionImplemented equal to true is called a multi-AP coordination (MAPC) capable STA (or AP); and STA (or AP) with dot11EHTBaseLineFeaturesImplementedOnly equal to true or with both dot11EHTBaseLineFeaturesImplementedOnly and dot11 Multi-APCoordinationOptionImplemented equal to false is called a MAPC incapable STA (or AP) thereafter.

An AP candidate set is a set of MAPC capable APs that can initiate or participate in a multi-AP coordination. A coordinator which is responsible for establishing and maintaining an AP candidate set may be a member AP of the AP candidate set or outside of the AP candidate set. An AP which obtains a TXOP and initiates a multi-AP coordination is the sharing AP. An AP in an AP candidate set can participate as a shared AP in a multi-AP coordination initiated by a sharing AP in the same AP candidate set. At least one AP in an AP candidate set shall be capable of being a sharing AP. A multi-AP coordination may include a multi-AP coordination preparation phase and a multi-AP coordinated transmission phase. In the multi-AP coordination preparation phase, a sharing AP obtaining a TXOP and initiating the multi-AP coordination may transmit a first frame to one or more AP in the same AP candidate set to inquire about respective intentions to participate in the multi-AP coordination. Each of the one or more AP will respond with a second frame to inform the sharing AP of whether it intends to participate in the multi-AP coordination. For example, the first frame may include information indicating an intended multi-AP coordination scheme, and any AP that receives the first frame may get that the sharing AP is inquiring about its intention to participate in the multi-AP coordination, based on the intended multi-AP coordination scheme. If an AP intends to participate in the multi-AP coordination, it becomes a shared AP in the multi-AP coordination. In the multi-AP coordinated transmission phase, the sharing AP and one or more shared AP may participate in a multi-AP coordinated transmission. Alternatively, the sharing AP may not participate in a multi-AP coordinated transmission; and two or more shared APs may participate in a multi-AP coordinated transmission.

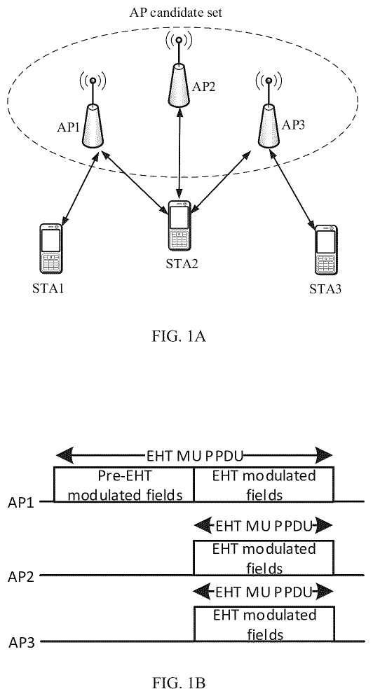

FIG. 1A illustrates an example AP candidate set which includes three APs: AP1, AP2 and AP3. In an instant, AP1 may obtain a TXOP and initiate a multi-AP coordination as the sharing AP while AP2 and AP3 may participate as the shared APs in the multi-AP coordination. AP1, AP2 and AP3 may participate in a multi-AP coordinated transmission (e.g., multi-AP coordinated DL OFDMA transmission or multi-AP DL joint transmission as illustrated in FIG. 1B) in the TXOP. In another instant, AP2 may obtain a TXOP and initiate a multi-AP coordination as the sharing AP; and AP1 and AP3 may participate as the shared APs in the multi-AP coordination. AP1 and AP3 may participate in a multi-AP coordinated transmission in the TXOP but AP2 does not participate in the multi-AP coordinated transmission.

According to some embodiments of the present disclosure, an AP candidate set forms a virtual BSS (VBSS), which may be identified by a MAC address (i.e., VBSSID). An AP candidate set or a VBSS can also be identified by a VBSS color. In one embodiment, VBSS colors are in a same value space with BSS colors. In this case, the value range of a VBSS color does not overlap with the value range of a BSS color. For example, the value of a BSS color ranges from 0 to N; and the value of a VBSS color ranges from N+1 to 63; where N is a positive integer ranging from 1 to 62 and the value of N is pre-defined or configurable. The value of N may be indicated in the Beacon, Probe Response frame, Association Response frame and/or Reassociation Response frame. In another embodiment, VBSS colors are in a different value space with BSS colors. In this case, the value range of a VBSS color may overlap with the value range of a BSS color. An AP may belong to more than one AP candidate set. An AP candidate set may include up to eight APs, and each AP in an AP candidate set is identified by an AP ID. An AP may indicate configuration information and operational parameters of each AP candidate set of which it is a member in transmitted Beacon and/or Probe Response frames. The configuration information and operational parameters of an AP candidate set may include SSID, Short SSID, VBSSID, VBSS color, BSSID of each member AP excluding the transmitting AP, BSS color of each member AP excluding the transmitting AP; and/or supported multi-AP coordinated transmission schemes. At any given instant, a MAPC capable STA is associated with no more than one AP candidate set. A MAPC capable STA may establish an association with an AP candidate set via a member AP of the AP candidate set wherein the member AP is called anchor AP of the STA. In one embodiment, the STA shall be associated with its anchor AP before it is associated with the AP candidate set via its anchor AP. In another embodiment, the STA may establish an association with its anchor AP and the AP candidate set simultaneously.

In some embodiments, during a MAPC capable STA establishes an association with an AP candidate set via its anchor AP, the AP candidate set's coordinator assigns a virtual AID (VAID) to the STA, which uniquely identifies the STA in the AP candidate set's VBSS. In one embodiment, VAIDs may be in a different value space from AIDs. In this case, the value range of a VAID may overlap with the value range of an AID. In another embodiment, VAIDs may be in a same value space as AIDs. In this case, the value range of a VAID does not overlap with the value range of an AID. For example, the value of an AID ranges from 1 to M; and the value of a VAID ranges from M+1 to 2007, where M is a positive integer ranging from 2 to 2006 and the value of M is pre-defined or configurable. The value of M may be indicated in the Beacon, Probe Response frame, Association Response frame and/or Reassociation Response frame.

After a MAPC capable STA is associated with an AP candidate set via its anchor AP, in the AP candidate set's VBSS, the STA may transmit a single PSDU to or receive one or more PSDU from one or more AP in the AP candidate set in a multi-AP coordinated transmission which involves more than one APs. In a multi-AP coordinated transmission, when a STA transmits a single PSDU to or receive more than one PSDUs from more than one APs, the more than one APs includes the STA's anchor AP. In a multi-AP coordinated transmission, when a STA transmits a single PSDU to or receive a single PSDU from a single AP, the AP is the STA's anchor AP. Alternatively, the AP is any AP involved in the multi-AP coordinated transmission. In addition, the STA may transmit a single PSDU to or receive a single PSDU from a single AP in a non-coordinated transmission. The single AP is STA's anchor AP. Alternatively, the single STA is any AP in the AP candidate set. Taking the multi-AP system as illustrated in FIG. 1A as an example where STA2's anchor AP is assumed to AP2. In a multi-AP coordinated transmission, STA2 may transmit a single PSDU to or receive a single PSDU from AP2 only; or transmit a single PSDU to or receive two or more PSDUs from AP2 and at least one of AP1 and AP3. In a non-coordinated transmission, STA2 may transmit a single PSDU to or receive a single PSDU from AP2 only.

A multi-AP coordinated DL transmission is a multi-AP coordinated DL OFDMA transmission or a multi-AP DL joint transmission. FIG. 1B illustrates that, in some embodiments, in a multi-AP DL joint transmission, two or more of sharing AP and shared AP(s) transmit respective EHT MU PPDUs to a single STA or different STAs at a single RU or MRU that occupies all non-punctured 20 MHz channels within a coordinated transmission bandwidth. In a multi-AP coordinated DL OFDMA transmission, two or more of sharing AP and shared AP(s) transmit respective EHT MU PPDUs to different STAs at different frequency portions of a coordinated transmission bandwidth where each frequency portion includes one or more 80 MHZ frequency subblock. In a multi-AP coordinated DL OFDMA transmission, more than one of sharing AP and shared AP(s) may transmit respective EHT MU PPDUs to a single STA or different STAs at a single RU or MRU that occupies all the non-punctured 20 MHz channels within a same frequency portion of a coordinated transmission bandwidth in a similar manner to a multi-AP DL joint transmission.

FIG. 1B illustrates that, in some embodiments, when multiple APs transmit respective EHT MU PPDUs which carry respective PSDUs for a same STA at a single RU or MRU that occupies all non-punctured 20 MHz channels within a coordinated transmission bandwidth or a frequency portion of the coordinated transmission bandwidth, the PSDUs for the STA are transmitted using a same FEC coding type and a same MCS. If the PSDUs for the STA have the same contents, they are transmitted using one or more same spatial streams. If the PSDUs for the STA have different contents, they are transmitted using different spatial streams.

In a multi-AP coordinated DL transmission, when multiple APs transmit respective EHT MU PPDUs at a single RU or MRU that occupies all non-punctured 20 MHz channels within a coordinated transmission bandwidth or a frequency portion of the coordinated transmission bandwidth, in one embodiment, not each of the EHT MU PPDUs transmitted by the multiple APs includes pre-EHT modulated fields and EHT modulated fields transmitted by the multiple APs start at the same time. For example, only one of the EHT MU PPDUs transmitted by the multiple APs includes the pre-EHT modulated fields, as illustrated in FIG. 1B. In particular, if the multiple APs includes a sharing AP which initiates the multi-AP coordinated DL transmission, only the EHT MU PPDU transmitted by the sharing AP includes the pre-EHT modulated fields. In this embodiment, a power scaling factor larger than one may be applied to the pre-EHT modulated fields. In other words, a transmission power of the pre-EHT modulated fields of the EHT MU PPDU may be larger than the EHT modulated fields of the EHT MU PPDU so that the pre-EHT modulated fields have same or similar overall transmission power to the EHT modulated fields for the EHT MU PPDUs transmitted by the multiple APs.

A multi-AP DL joint transmission is applicable to a coordinated transmission bandwidth of 20 MHz, 40 MHz, 80 MHz, 160 MHz or 320 MHz. A multi-AP coordinated DL OFDMA transmission is applicable to a coordinated transmission bandwidth of 160 MHz or 320 MHz but not applicable to a coordinated transmission bandwidth of 20 MHz, 40 MHz or 80 MHz. In a multi-AP coordinated DL transmission, EHT MU PPDUs transmitted by two or more of sharing AP and shared AP(s) shall have a same number of EHT-SIG symbols, a same GI and EHT-LTF type, a same number of EHT-LTF symbols and a same duration of Data field and PE field. As a result, all the EHT MU PPDUs have a same transmission time. When two or more of sharing AP and shared AP(s) transmit respective EHT MU PPDUs at a single RU or MRU that occupies all non-punctured 20 MHz channels within a coordinated transmission bandwidth or a same frequency portion of a coordinated transmission bandwidth, the U-SIG fields of the transmitted EHT MU PPDUs shall have the same content; and the EHT-SIG fields of the transmitted EHT MU PPDUs shall have the same content as well.

In a multi-AP coordinated DL OFDMA transmission, EHT MU PPDUs transmitted by two or more of sharing AP and shared AP(s) are aggregated in frequency domain and forms a MU A-PPDU. A MU A-PPDU consists of multiple EHT MU PPDU sets, each of which includes one or more EHT MU PPDUs transmitted at a same frequency portion of the coordinated transmission bandwidth. The number of EHT MU PPDUs in an EHT MU PPDU set affiliated with a frequency portion of the coordinated transmission bandwidth equals to the number of APs to which the frequency portion is allocated. For example, if a frequency portion of the coordinated transmission bandwidth is allocated to a single AP (e.g. the sharing AP or a shared AP), the EHT MU PPDU set affiliated with the frequency portion includes a single EHT MU PPDU. If a frequency portion of the coordinated transmission bandwidth is allocated to three APs (e.g. the sharing AP and two shared APs, or three shared APs), the EHT MU PPDU set affiliated with the frequency portion includes three EHT MU PPDUs.

For a multi-AP coordinated DL OFDMA transmission with a coordinated transmission bandwidth of 160 MHz, two 80 MHz frequency subblocks are allocated to two EHT MU PPDU sets, respectively. For a multi-AP coordinated DL OFDMA transmission with a coordinated transmission bandwidth of 320 MHZ, there may have the following five options for bandwidth allocation for multiple EHT MU PPDU sets:

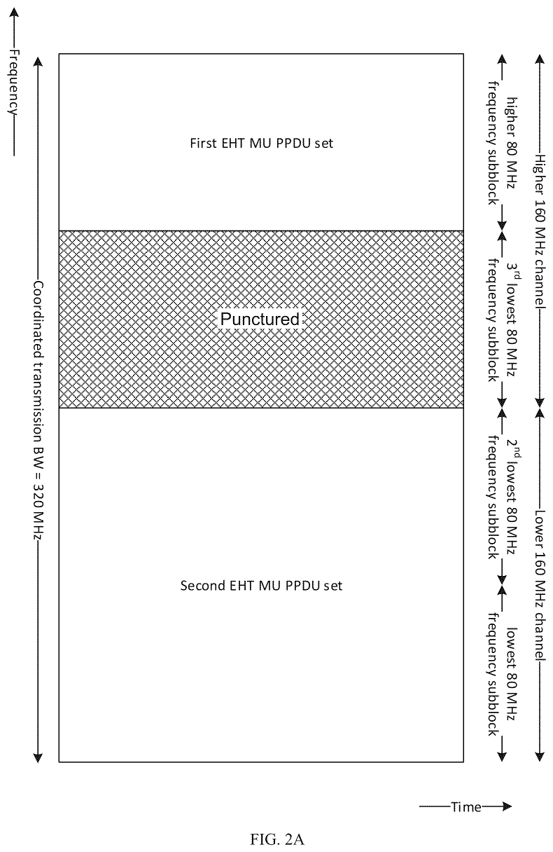

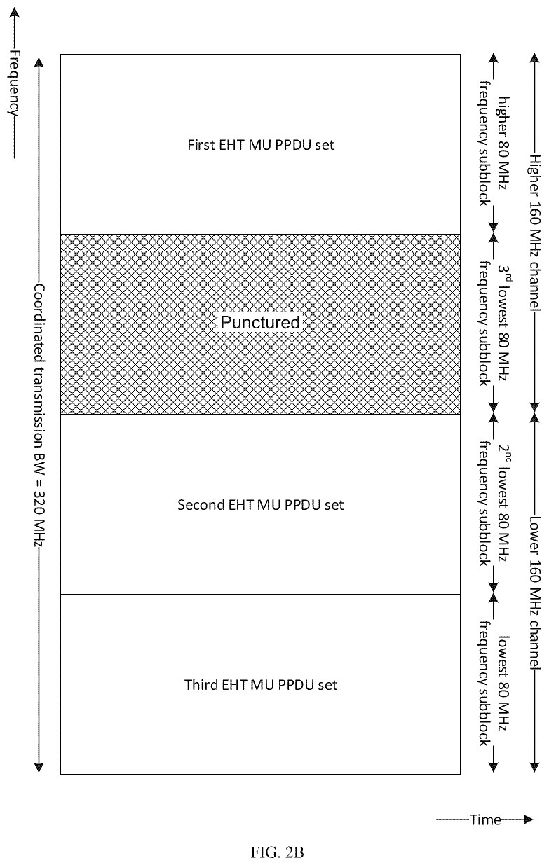

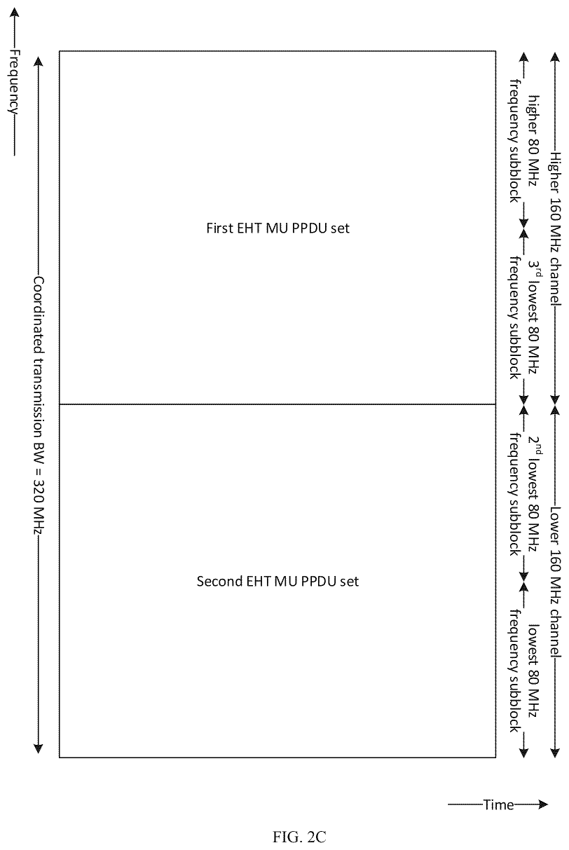

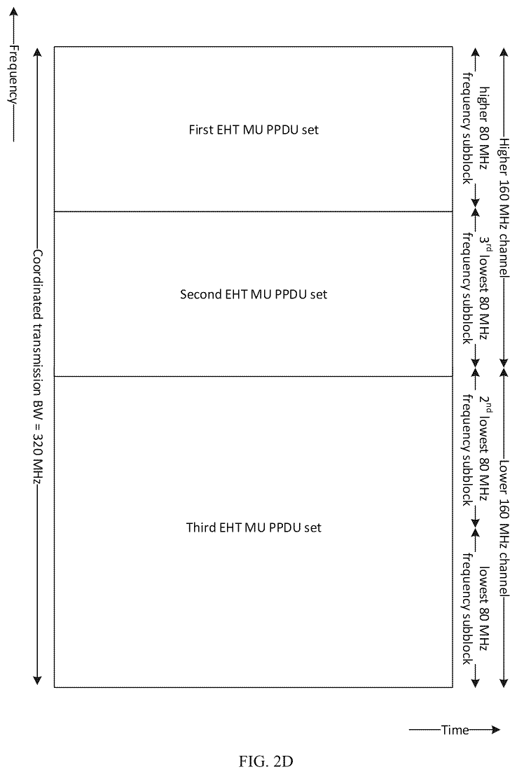

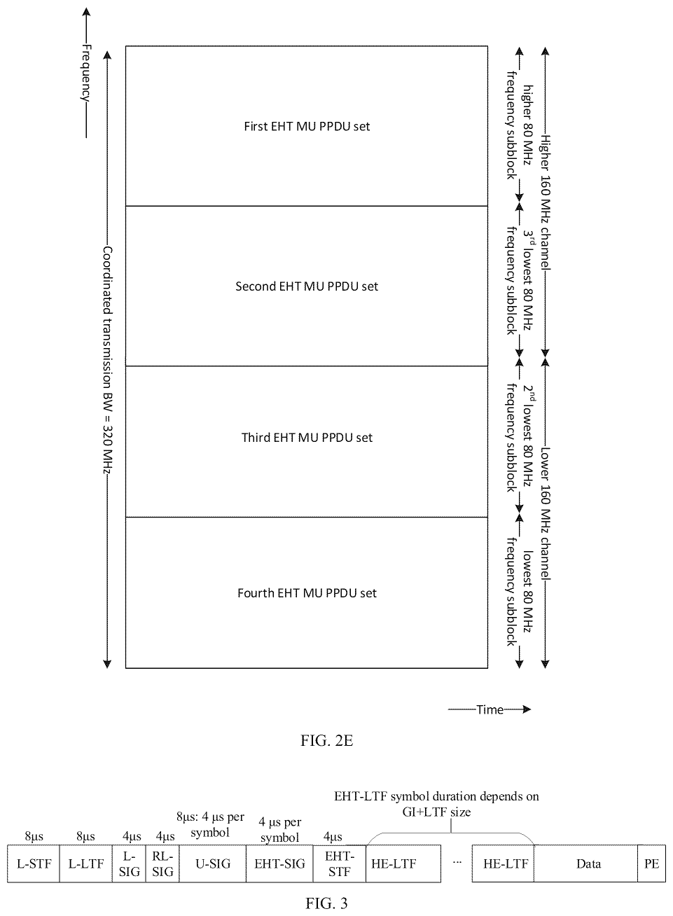

Option IA: When one of 80 MHz frequency subblocks is punctured, the unpunctured 80 MHz frequency subblock which is within a same 160 MHz channel as the punctured 80 MHZ frequency subblock is allocated to a first EHT MU PPDU set, and the other 160 MHz channel is allocated to a second EHT MU PPDU set, as illustrated in FIG. 2A.

Option 1B: When one of 80 MHz frequency subblocks is punctured, three unpunctured 80 MHz frequency subblocks are allocated to three EHT MU PPDU sets, respectively, as illustrated in FIG. 2B.

Option IC: Two 160 MHz channels are allocated to two EHT MU PPDU sets, respectively, as illustrated in FIG. 2C.

Option ID: Two 80 MHz frequency subblocks within a same 160 MHz channel are allocated to first two EHT MU PPDU sets, respectively; and the other 160 MHz channel is allocated to a third EHT MU PPDU set, as illustrated in FIG. 2D.

Option IE: Four 80 MHz frequency subblocks are allocated to four EHT MU PPDU sets, respectively, as illustrated in FIG. 2E.

The EHT MU PPDU format as illustrated in FIG. 3 is used for a transmission that is not a response to a Trigger frame from an AP. The L-STF, L-LTF, L-SIG, RL-SIG, U-SIG and EHT-SIG are called pre-EHT modulated fields while the EHT-STF, EHT-LTF, Data field and PE are called EHT modulated fields. The U-SIG field includes two OFDM symbols, each having a duration of 4 us. Each EHT-LTF symbol has the same GI duration as each data symbol, which is 0.8 us, 1.6 us or 3.2 us. The EHT-LTF includes three types: 1×EHT-LTF, 2×EHT-LTF and 4× EHT-LTF. The duration of each 1×EHT-LTF, 2×EHT-LTF or 4×EHT-LTF symbol without GI is 3.2 us, 6.4 us or 12.8 us. Each data symbol without GI is 12.8 us. The PE duration of an EHT MU PPDU is 0 us, 4 us, 8 us, 12 us, 16 us or 20 us. For example, in details, the U-SIG has two OFDM symbols and each symbol is 4 us. The number of EHT-SIG symbols may be variable. As a result, EHT-SIG duration may not be 8 us.

U-SIG field carries information necessary to interpret EHT MU PPDUs. The U-SIG field is designed to bring forward compatibility to the EHT preamble via the introduction of version independent fields. These are the fields that will be consistent in location and interpretation across multiple IEEE 802.11 PHY versions. The intent of the version independent content is to achieve better coexistence among IEEE 802.11 PHY versions that are defined for 2.4, 5, and 6 GHZ spectrum from EHT PHY onwards. In addition, the U-SIG can have some version dependent fields that are fields specific to an IEEE 802.11 PHY version. The U-SIG includes version independent bits followed by version dependent bits. In addition, the U-SIG field includes one or more Validate fields. Validate field values serve to indicate whether to continue reception of an EHT MU PPDU at an STA. If an STA encounters an EHT MU PPDU where at least one field in the preamble that is identified as Validate for the STA is not set to the value specified for the field, the STA shall defer for the duration of the EHT MU PPDU, report the information from the version independent fields within the RXVECTOR, and terminate the reception of the EHT MU PPDU.

### Embodiment 1

According to the first embodiment, the U-SIG field of an EHT MU PPDU may include a BSS/VBSS subfield and a BSS/VBSS Color subfield. For a MAPC capable STA, the BSS/VBSS subfield is interpreted to indicate whether the EHT MU PPDU is transmitted in a BSS or VBSS. For example, the BSS/VBSS subfield is set to a first value (e.g., 1) to indicate the EHT MU PPDU is transmitted in a BSS; and set to a second value (e.g., 0) to indicate that the EHT MU PPDU is transmitted in a VBSS. For example, the BSS/VBSS subfield is set to a second value (e.g., 0) to indicate the EHT MU PPDU is transmitted in a BSS; and set to a first value (e.g., 1) to indicate that the EHT MU PPDU is transmitted in a VBSS. In a multi-AP coordinated DL transmission, when the EHT MU PPDU, together with any of other EHT MU PPDUs, is transmitted at a same RU or MRU that occupies all non-punctured 20 MHz channels within a coordinated transmission bandwidth or a frequency portion of the coordinated transmission bandwidth, the BSS/VBSS subfield shall be set to indicate that the EHT MU PPDU is transmitted in a VBSS. When the EHT

MU PPDU is transmitted a different RU or MRU from any of other EHT MU PPDUs, the BSS/VBSS subfield may be set to indicate that the EHT MU PPDU is transmitted in a BSS if the transmitting AP is the anchor AP of all the STAs intended by the EHT MU PPDU; and shall be set to indicate that the EHT MU PPDU is transmitted in a VBSS otherwise. For a MAPC incapable STA, the BSS/VBSS subfield is always interpreted to a Validate field which shall be set to 1. In other words, when a MAPC incapable STA receives an EHT MU PPDU with the BSS/VBSS subfield of U-SIG field set to 0, it would terminate the reception of the EHT MU PPDU. For a MAPC capable STA, the BSS/VBSS Color subfield is interpreted according to the value of the BSS/VBSS subfield. When the BSS/VBSS subfield is set to indicate the EHT MU PPDU is transmitted in a BSS, the BSS/VBSS Color subfield is interpreted to a BSS Color subfield which indicates a BSS color of the transmitting AP. When the BSS/VBSS subfield is set to indicate that the EHT MU PPDU is transmitted in a VBSS, the BSS/VBSS Color subfield is interpreted to a VBSS Color subfield which indicates a VBSS color of the AP candidate set. For a MAPC incapable STA, the BSS/VBSS Color subfield of the U-SIG field is always interpreted to the BSS Color subfield.

If the transmitting AP is a MAPC capable AP and the EHT MU PPDU is transmitted in a BSS, the BSS/VBSS subfield is set by the transmitting AP to indicate a transmission in the transmitting AP's BSS and the BSS/VBSS Color subfield is set by the transmitting AP to indicate a BSS color of the transmitting AP. If the transmitting AP is a MAPC capable AP and the EHT MU PPDU is transmitted in a VBSS, the BSS/VBSS subfield is set by the transmitting AP to indicate a transmission in the AP candidate set's VBSS and the VBSS/BSS Color subfield is set by the transmitting AP to indicate a VBSS color of the AP candidate set. If the transmitting AP is a MAPC incapable AP, the BSS/VBSS subfield is set by the transmitting AP to indicate a transmission in the transmitting AP's BSS and the BSS/VBSS Color subfield is set by the transmitting AP to indicate a BSS color of the transmitting AP.

In one embodiment, the BSS/VBSS subfield is one of the version independent fields of the U-SIG field. In this case, the BSS/VBSS subfield corresponds to B25 of the U-SIG-1 of the U-SIG field. In another embodiment, the BSS/VBSS subfield is one of the version dependent fields of the U-SIG field. In this case, the BSS/VBSS subfield corresponds to B2 or B8 of the U-SIG-2 of the U-SIG field. An example format of U-SIG field of EHT MU PPDU according to the first embodiment is illustrated in Table 2.

TABLE 2

| Two parts | | | Number | |
|---|---|---|---|---|
| of U-SIG | Bit | Field | of bits | Description |
| U-SIG-1 | B0-B2 | PHY Version | 3 | Differentiate between different |
| | | Identifier | | PHY clauses. |
| | | | | Set to 0 for EHT. |
| | | | | Values 1-7 are Validate. |
| | B3-B5 | BW | 3 | Set to 0 for 20 MHz; |
| | | | | Set to 1 for 40 MHz. |
| | | | | Set to 2 for 80 MHz; |
| | | | | Set to 3 for 160 MHz; |
| | | | | Set to 4 for 320 MHz-1; |
| | | | | Set to 5 for 320 MHz-2. |
| | | | | Values 6 and 7 are Validate. |
| | B6 | UL/DL | 1 | Set to 1 to indicate that the |
| | | | | PPDU is addressed to the AP; |
| | | | | set to 0 otherwise. |
| | B7-B12 | BSS/VBSS Color | 6 | When the EHT MU PPDU is |
| | | | | transmitted in a BSS, |
| | | | | indicates a BSS color of |
| | | | | the BSS; |
| | | | | When the EHT MU PPDU is |
| | | | | transmitted in a VBSS, |
| | | | | indicates a VBSS color of |
| | | | | the VBSS. |
| | B13-B19 | TXOP | 7 | Set to 127 to indicate no |
| | | | | duration information. |
| | | | | Set to a value less than |
| | | | | 127 to indicate duration |
| | | | | information for NAV setting |
| | | | | and protection of the TXOP. |
| | B20-B24 | Disregard | 5 | Set to all 1s and Disregard. |
| | B25 | BSS/VBSS | 1 | Set to 1 to indicate the |
| | | | | EHT MU PPDU is transmitted |
| | | | | in a BSS; and set to 0 to |
| | | | | indicate the EHT MU PPDU is |
| | | | | transmitted in a VBSS. |
| U-SIG-2 | B0-B1 | PPDU Type And | 2 | If the UL/DL field is set to |
| | | Compression | | 0, a value of 0 indicates a |
| | | Mode | | DL OFDMA transmission; and a |
| | | | | value of 2 indicates a non- |
| | | | | OFDMA DL MU-MIMO transmission. |
| | | | | A value of 1 indicates a |
| | | | | transmission to a single |
| | | | | user or an EHT sounding NDP |
| | | | | regardless of UL/DL. |
| | | | | Undefined values of this field |
| | | | | are Validate. |
| | B2 | Validate | 1 | Set to 1 and Validate. |
| | B3-B7 | Punctured Channel | 5 | If the PPDU Type And |
| | | Information | | Compression Mode field is |
| | | | | set to 1 or 2: |
| | | | | B3-B7 points to the entry of |
| | | | | a bandwidth dependent table |
| | | | | (defined in Table 36-30 of |
| | | | | IEEE 802.11be D1.1) to signal |
| | | | | the non-OFDMA puncturing pattern |
| | | | | of the entire PPDU bandwidth. |
| | | | | Undefined values of this field |
| | | | | are Validate. |
| | | | | If the PPDU Type And Compression |
| | | | | Mode field is set to 0: |
| | | | | If the BW field is set to a |
| | | | | value between 2 and 5, B3- |
| | | | | B6 is a 4-bit bitmap that |
| | | | | indicates which 20 MHz |
| | | | | channel is punctured in the |
| | | | | relevant 80 MHz subblock, |
| | | | | where B3-B6 apply to from the |
| | | | | lowest to the highest frequency |
| | | | | 20 MHz channels. For each of |
| | | | | the bits B3-B6, a value of 0 |
| | | | | indicates that the corresponding |
| | | | | 20 MHz channel is punctured, and |
| | | | | a value of 1 is used otherwise. |
| | | | | The following allowed punctured |
| | | | | patterns (B3-B6) are defined for |
| | | | | an 80 MHz subblock: 1111 (no |
| | | | | puncturing), 0111, 1011, 1101, |
| | | | | 1110, 0011, 1100, and 1001. Any |
| | | | | field values other than the |
| | | | | allowed punctured patterns are |
| | | | | Validate. Field value may be |
| | | | | varied from one 80 MHz to the |
| | | | | other. |
| | | | | If the BW field is set to 0 or |
| | | | | 1, B3-B6 are set to all 1s. Other |
| | | | | values are Validate. |
| | | | | B7 is set to 1 and Disregard. |
| | B8 | Validate | 1 | Set to 1 and Validate. |
| | B9-B10 | EHT-SIG MCS | 2 | Indicates the MCS used for |
| | | | | modulating the EHT-SIG. |
| | | | | Set to 0 for EHT-MCS 0. |
| | | | | Set to 1 for EHT-MCS 1. |
| | | | | Set to 2 for EHT-MCS 3. |
| | | | | Set to 3 for EHT-MCS 15. |
| | B11-B15 | Number Of | 5 | Indicates the number of EHT-SIG |
| | | EHT-SIG | | symbols. |
| | | Symbols | | Set to a value that is the number |
| | | | | of EHT-SIG symbols minus 1. |
| | | | | This value shall be the same in |
| | | | | every 80 MHz subblock. |
| | B16-B19 | CRC | 4 | CRC for bits 0-41 of the U-SIG |
| | | | | field. Bits 0-41 of the U-SIG |
| | | | | field correspond to bits 0-25 of |
| | | | | U- SIG-1 followed by bits 0-15 |
| | | | | of U-SIG-2. |
| | B20-B25 | Tail | 6 | Used to terminate the trellis |
| | | | | of the convolutional decoder. |
| | | | | Set to 0. |

### Embodiment 2

In the second embodiment, it is assumed that VBSS colors are in a same value space with BSS colors. In this case, the value range of a VBSS color does not overlap with the value range of a BSS color. According to the second embodiment, the U-SIG field of an EHT MU PPDU may include a BSS/VBSS Color subfield. For a MAPC capable STA, the BSS/VBSS Color subfield is interpreted according to the value of the BSS/VBSS Color subfield. When the value of the BSS/VBSS Color subfield is in the value range of a BSS color, the BSS/VBSS Color subfield is interpreted to a BSS Color subfield which indicates a BSS color of the transmitting AP. When the value of the BSS/VBSS Color subfield is in the value range of a VBSS color, the BSS/VBSS Color subfield is interpreted to a VBSS Color subfield which indicates a VBSS color of the AP candidate set. For a MAPC incapable STA, the BSS/VBSS Color subfield is always interpreted to the BSS Color subfield.

In a multi-AP coordinated DL transmission, when the EHT MU PPDU, together with any of other EHT MU PPDUs, is transmitted at a same RU or MRU that occupies all non-punctured 20 MHz channels within a coordinated transmission bandwidth or a frequency portion of the coordinated transmission bandwidth, the EHT MU PPDU shall be transmitted in a VBSS. When the EHT MU PPDU is transmitted at a different RU or MRU from any of other EHT MU PPDUS, the EHT MU PPDU may be transmitted in a BSS if the transmitting AP is the anchor AP of all the STAs intended by the EHT MU PPDU; and shall be transmitted in a VBSS otherwise. If the transmitting AP is a MAPC capable AP and the EHT MU PPDU is transmitted in a BSS, the BSS/VBSS Color subfield is set by the transmitting AP to indicate a BSS color of the transmitting AP. If the transmitting AP is a MAPC capable AP and the EHT MU PPDU is transmitted in a VBSS, the VBSS/BSS Color subfield is set by the transmitting AP to indicate a VBSS color of the AP candidate set. If the transmitting AP is a MAPC incapable AP, the BSS/VBSS Color subfield is always set by the transmitting AP to indicate a BSS color of the transmitting AP. An example format of U-SIG field of EHT MU PPDU according to the second embodiment is illustrated in Table 3.

TABLE 3

| Two parts | | | Number | |
|---|---|---|---|---|
| of U-SIG | Bit | Field | of bits | Description |
| U-SIG-1 | B0-B2 | PHY Version | 3 | Differentiate between different PHY |
| | | Identifier | | clauses. |
| | | | | Set to 0 for EHT. |
| | | | | Values 1-7 are Validate. |
| | B3-B5 | BW | 3 | Set to 0 for 20 MHz; |
| | | | | Set to 1 for 40 MHz. |
| | | | | Set to 2 for 80 MHz; |
| | | | | Set to 3 for 160 MHz; |
| | | | | Set to 4 for 320 MHz-1; |
| | | | | Set to 5 for 320 MHz-2. |
| | | | | Values 6 and 7 are Validate. |
| | B6 | UL/DL | 1 | Set to 1 to indicate that the PPDU |
| | | | | is addressed to the AP; and set to |
| | | | | 0 otherwise. |
| | B7-B12 | BSS/VBSS Color | 6 | When the EHT MU PPDU is |
| | | | | transmitted in a BSS, indicates a |
| | | | | BSS color of the BSS; |
| | | | | When the EHT MU PPDU is |
| | | | | transmitted in a VBSS, indicates |
| | | | | a VBSS color of the VBSS. |
| | B13-B19 | TXOP | 7 | Set to 127 to indicate no |
| | | | | duration information. |
| | | | | Set to a value less than 127 to |
| | | | | indicate duration information for |
| | | | | NAV setting and protection of |
| | | | | the TXOP. |
| | B20-B24 | Disregard | 5 | Set to all 1s and Disregard. |
| | B25 | Validate | 1 | Set to 1 and Validate. |
| U-SIG-2 | B0-B1 | PPDU Type And | 2 | If the UL/DL field is set to 0, |
| | | Compression | | a value of 0 indicates a DL |
| | | Mode | | OFDMA transmission; and a value |
| | | | | of 2 indicates a non-OFDMA DL |
| | | | | MU-MIMO transmission. |
| | | | | A value of 1 indicates a |
| | | | | transmission to a single user |
| | | | | or an EHT sounding NDP regardless |
| | | | | of UL/DL. |
| | | | | Undefined values of this field |
| | | | | are Validate. |
| | B2 | Validate | 1 | Set to 1 and Validate. |
| | B3-B7 | Punctured Channel | 5 | If the PPDU Type And Compression |
| | | Information | | Mode field is set to 1 or 2: |
| | | | | B3-B7 points to the entry of a |
| | | | | bandwidth dependent table |
| | | | | (defined in Table 36-30 of IEEE |
| | | | | 802.11be D1.1) to signal the |
| | | | | non- OFDMA puncturing pattern of |
| | | | | the entire PPDU bandwidth. |
| | | | | Undefined values of this field |
| | | | | are Validate. |
| | | | | If the PPDU Type And Compression |
| | | | | Mode field is set to 0: |
| | | | | If the BW field is set to a value |
| | | | | between 2 and 5, B3-B6 is a 4-bit |
| | | | | bitmap that indicates which 20 |
| | | | | MHz channel is punctured in the |
| | | | | relevant 80 MHz subblock, where |
| | | | | B3-B6 apply to from the lowest |
| | | | | to the highest frequency 20 MHz |
| | | | | channels. For each of the bits |
| | | | | B3-B6, a value of 0 indicates |
| | | | | that the corresponding 20 MHz |
| | | | | channel is punctured, and a value |
| | | | | of 1 is used otherwise. The |
| | | | | following allowed punctured |
| | | | | patterns (B3-B6) are defined |
| | | | | for an 80 MHz subblock: 1111 (no |
| | | | | puncturing), 0111, 1011, 1101, |
| | | | | 1110, 0011, 1100, and 1001. Any |
| | | | | field values other than the |
| | | | | allowed punctured patterns are |
| | | | | Validate. Field value may be |
| | | | | varied from one 80 MHz to the |
| | | | | other. |
| | | | | If the BW field is set to 0 or |
| | | | | 1, B3-B6 are set to all 1s. Other |
| | | | | values are Validate. |
| | | | | B7 is set to 1 and Disregard. |
| | B8 | Validate | 1 | Set to 1 and Validate. |
| | B9-B10 | EHT-SIG MCS | 2 | Indicates the MCS used for |
| | | | | modulating the EHT-SIG. |
| | | | | Set to 0 for EHT-MCS 0. |
| | | | | Set to 1 for EHT-MCS 1. |
| | | | | Set to 2 for EHT-MCS 3. |
| | | | | Set to 3 for EHT-MCS 15. |
| | B11-B15 | Number Of | 5 | Indicates the number of EHT- |
| | | EHT-SIG | | SIG symbols. Set to a value |
| | | Symbols | | that is the number of EHT-SIG |
| | | | | symbols minus 1. |
| | | | | This value shall be the same |
| | | | | in every 80 MHz subblock. |
| | B16-B19 | CRC | 4 | CRC for bits 0-41 of the U-SIG |
| | | | | field. |
| | | | | Bits 0-41 of the U-SIG field |
| | | | | correspondto bits 0-25 of U- |
| | | | | SIG-1 followed by bits 0-15 |
| | | | | of U-SIG-2. |
| | B20-B25 | Tail | 6 | Used to terminate the trellis |
| | | | | of the convolutional decoder. |
| | | | | Set to 0. |

The EHT-SIG field provides additional signaling to the U-SIG field for STAs to interpret an EHT MU PPDU. The EHT-SIG field of a 20 MHz EHT MU PPDU contains one EHT-SIG content channel. For OFDMA transmission and for non-OFDMA transmission to multiple users, the EHT-SIG field of an EHT MU PPDU that is 40 MHz or 80 MHz contains two EHT-SIG content channels, and the EHT-SIG field of an EHT MU PPDU that is 160 MHz or wider contains two EHT-SIG content channels per 80 MHz. The EHT-SIG content channels per 80 MHz are allowed to carry different information when EHT MU PPDU bandwidth for OFDMA transmission is wider than 80 MHz. The EHT-SIG field of an EHT MU PPDU sent to a single user contains one EHT-SIG content channel and it is duplicated per 20 MHz when the EHT PPDU is equal to or wider than 40 MHz. For an EHT MU PPDU, the EHT-SIG content channel consists of a Common field followed by a User Specific field. An example format of Common field of EHT MU PPDU for OFDMA transmission is illustrated in Table 36-33 of IEEE 802.11be D1.2. An example format of Common field of EHT MU PPDU for non-OFDMA transmission is illustrated in Table 36-34 of IEEE 802.11be D1.2. In each EHT-SIG content channel, the User Specific field includes one or more User field.

### Embodiment 3

According to the third embodiment, a User field for a non-MU-MIMO allocation or a MU-MIMO allocation may include a STA-ID/VSTA-ID subfield which indicates the STA addressed by the User field. If the transmitting AP is a MAPC capable AP and the EHT MU PPDU is transmitted in a BSS, the STA-ID/VSTA-ID subfield is set by the transmitting AP to a value of the TXVECTOR parameter STA_ID. If the transmitting AP is a MAPC capable AP and the EHT MU PPDU is transmitted in a VBSS, the STA-ID/VSTA-ID subfield is set by the transmitting AP to a value of the TXVECTOR parameter VSTA_ID. If the transmitting AP is a MAPC incapable AP, the STA-ID/VSTA-ID subfield is always set by the transmitting AP to a value of the TXVECTOR parameter STA_ID.

For a MAPC capable STA, how the STA-ID/VSTA-ID subfield is interpreted depending on whether the EHT MU PPDU is transmitted in a BSS or VBSS, which is determined by the STA according to the value of the BSS/VBSS subfield of U-SIG field according to the first embodiment or the value of the BSS/VBSS Color subfield of U-SIG field according to the second embodiment. For a MAPC incapable STA, the STA-ID/VSTA-ID subfield is always interpreted to the STA-ID subfield. The TXVECTOR parameter STA_ID is defined in the IEEE 802.11be D1.2. The TXVECTOR parameter VSTA_ID indicates the list of VSTA-IDs for an EHT MU PPDU transmitted in a VBSS. Each parameter VSTA_ID in the TXVECTOR identifies the STA or group of STAs that is the recipient of an RU or MRU in the EHT MU PPDU. For an individually addressed RU or MRU, the parameter VSTA_ID is set to the 11 LSBs of the VAID of the STA receiving the PSDU contained in that RU or MRU. If an RU or MRU is intended for one or more STAs which are unassociated with the AP candidate set, then the parameter STA_ID for that RU or MRU is set to 2045. If an RU or MRU is intended for no user, then the parameter VSTA_ID for that RU or MRU is set to 2046. if the RU or MRU is intended for more than one associated STA in the VBSS that is not a recipient of an individually addressed RU or MRU, the parameter STA_ID for that RU or MRU is set to 0. The User field format for a non-MU-MIMO allocation according to the third embodiment is defined in Table 4; and the User field format for a MU-MIMO allocation according to the third embodiment is defined in Table 5.

TABLE 4

| | | Number | |
|---|---|---|---|
| Bit | Subfield | of bits | Description |
| B0-B10 | STA-ID/ | 11 | When the EHT MU PPDU is |
| | VSTA-ID | | transmitted in a BSS, |
| | | | indicates a value of TXVECTOR |
| | | | parameter STA_ID; |
| | | | When the EHT MU PPDU is |
| | | | transmitted in a VBSS, |
| | | | indicates a value of TXVECTOR |
| | | | parameter VSTA_ID. |
| B11-B14 | MCS | 4 | If the STA-ID/VSTA-ID subfield |
| | | | is not 2046, this subfield |
| | | | indicates the following modulation |
| | | | and coding scheme: |
| | | | Set to n for EHT-MCS n, where |
| | | | n = 0, 1, . . . , 15. |
| | | | Set to an arbitrary value if |
| | | | the STA-ID/VSTA-ID subfield |
| | | | is 2046. |
| | | | If the value of STA-ID/VSTA-ID |
| | | | subfield matches the user's |
| | | | STA-ID or VSTA-ID, the value |
| | | | of EHT-MCS 14 or EHT-MCS 15 is |
| | | | Validate if the condition |
| | | | described in 36.1.1 of IEEE |
| | | | 802.11be D1.2 is not met. If |
| | | | the value of STA-ID/VSTA-ID |
| | | | subfield does not match the |
| | | | user's STA-ID or VSTA-ID, all |
| | | | values are Disregard. |
| B15 | Reserved | 1 | Reserved and set to 1. |
| | | | If the value of/VSTA-ID |
| | | | subfield matches the user's |
| | | | STA-ID or VSTA-ID, the |
| | | | Reserved subfield is Validate. |
| | | | If the value of STA-ID/VSTA-ID |
| | | | subfield does not match the |
| | | | user's STA-ID or VSTA-ID and |
| | | | the Reserved subfield is Disregard. |
| B16-B19 | NSS | 4 | If the STA-ID/VSTA-ID subfield |
| | | | is not equal to 2046, it indicates |
| | | | the number of spatial streams for |
| | | | up to eight spatial streams. |
| | | | Set to the number of spatial |
| | | | streams minus 1. |
| | | | Set to an arbitrary value if the |
| | | | STA-ID/VSTA-ID subfield is |
| | | | equal to 2046. |
| | | | If the value of STA-ID/VSTA-ID |
| | | | subfield matches the user's STA- |
| | | | ID or VSTA-ID, other values are |
| | | | Validate. If the value of STA- |
| | | | ID/VSTA-ID subfield does not |
| | | | match the user's STA-ID or |
| | | | VSTA-ID, all values are |
| | | | Disregard. |
| B20 | Beamformed | 1 | If the STA-ID/VSTA-ID subfield |
| | | | is not 2046, this subfield is |
| | | | used to indicate transmit |
| | | | beamforming: |
| | | | Set to 1 if a beamforming |
| | | | steering matrix is applied to |
| | | | the waveform in a non-MU-MIMO |
| | | | allocation. |
| | | | Set to 0 otherwise. |
| | | | Set to an arbitrary value if |
| | | | the STA-ID/VSTA-ID subfield is |
| | | | 2046. |
| B21 | Coding | 1 | If the STA-ID/VSTA-ID subfield |
| | | | is not equal to 2046, this |
| | | | subfield indicates whether BCC |
| | | | or LDPC is used: |
| | | | Set to 0 for BCC. |
| | | | Set to 1 for LDPC. |
| | | | Set to an arbitrary value if |
| | | | the STA-ID/VSTA-ID subfield is |
| | | | 2046. |
| | | | If the value of STA-ID/VSTA-ID |
| | | | subfield does not match the |
| | | | user's STA-ID or VSTA-ID, all |
| | | | values are Disregard. |

TABLE 5

| | | Number | |
|---|---|---|---|
| Bit | Subfield | of bits | Description |
| B0-B10 | STA-ID/ | 11 | When the EHT MU PPDU |
| | VSTA-ID | | is transmitted in a |
| | | | BSS, indicates a value |
| | | | of TXVECTOR parameter |
| | | | STA_ID; |
| | | | When the EHT MU PPDU |
| | | | is transmitted in a |
| | | | VBSS, indicates a value |
| | | | of TXVECTOR parameter |
| | | | VSTA_ID. |
| B11-B14 | MCS | 4 | If the STA-ID/VSTA-ID |
| | | | subfield is not equal |
| | | | to 2046, this subfield |
| | | | indicates the following |
| | | | modulation and coding |
| | | | scheme: |
| | | | Set to n for EHT-MCS n, |
| | | | where n = 0,1, . . . , |
| | | | 13. |
| | | | Set to an arbitrary |
| | | | value if the STA-ID/ |
| | | | VSTA-ID subfield is |
| | | | equal to 2046. |
| | | | If the value of STA- |
| | | | ID subfield matches |
| | | | the user's STA-ID |
| | | | or VSTA-ID, other |
| | | | values are Validate. |
| | | | If the value of STA-ID/ |
| | | | VSTA-ID subfield does |
| | | | not match the user's |
| | | | STA-ID or VSTA-ID, all |
| | | | values are Disregard. |
| B15 | Coding | 1 | If the STA-ID/VSTA-ID |
| | | | subfield is not equal |
| | | | to 2046, this subfield |
| | | | indicates whether BCC |
| | | | or LDPC is used: |
| | | | Set to 0 for BCC. |
| | | | Set to 1 for LDPC. |
| | | | If the RU size is |
| | | | larger than 242, this |
| | | | bit is reserved and |
| | | | set to 1. |
| | | | Set to an arbitrary |
| | | | value if the STA-ID/ |
| | | | VSTA-ID subfield is |
| | | | equal to 2046. |
| | | | If the value of STA-ID |
| | | | subfield matches the |
| | | | user's STA-ID, the |
| | | | Reserved subfield is |
| | | | Validate. If the value |
| | | | of STA-ID subfield does |
| | | | not match the user's |
| | | | STA-ID,the Reserved |
| | | | subfield is Disregard. |
| B16-B21 | Spatial | 6 | Indicates the number of |
| | Configuration | | spatial streams for a |
| | | | user in a MU-MIMO |
| | | | allocation. |
| | | | If STA-ID or VSTA-ID |
| | | | matches, the values |
| | | | that are reserved or |
| | | | do not exist in Table |
| | | | 36-42 of IEEE 802.11be |
| | | | D1.2 are Validate. |
| | | | If STA-ID or VSTA-ID |
| | | | does not match, all |
| | | | values are Disregard. |

### Embodiment 4

According to the fourth embodiment, the format of a User field for a non-MU-MIMO allocation or a MU-MIMO allocation depends on whether the EHT MU PPDU is transmitted in a BSS or VBSS. If the EHT MU PPDU is transmitted in a BSS, the format of a User field for a non-MU-MIMO allocation or a MU-MIMO allocation is defined in Table 36-40 or Table 36-41 of the IEEE 802.11be D1.2. If the EHT MU PPDU is transmitted in a VBSS, a User field for a non-MU-MIMO allocation or a MU-MIMO allocation may include an AP ID subfield which, together with a STA-ID subfield, indicates the STA addressed by the User field. The AP ID subfield is set to its AP ID in the AP candidate set corresponding to the VBSS color as specified in the U-SIG field; and the STA-ID subfield is set to a value of the TXVECTOR parameter STA_ID corresponding to the STA addressed by the User field.

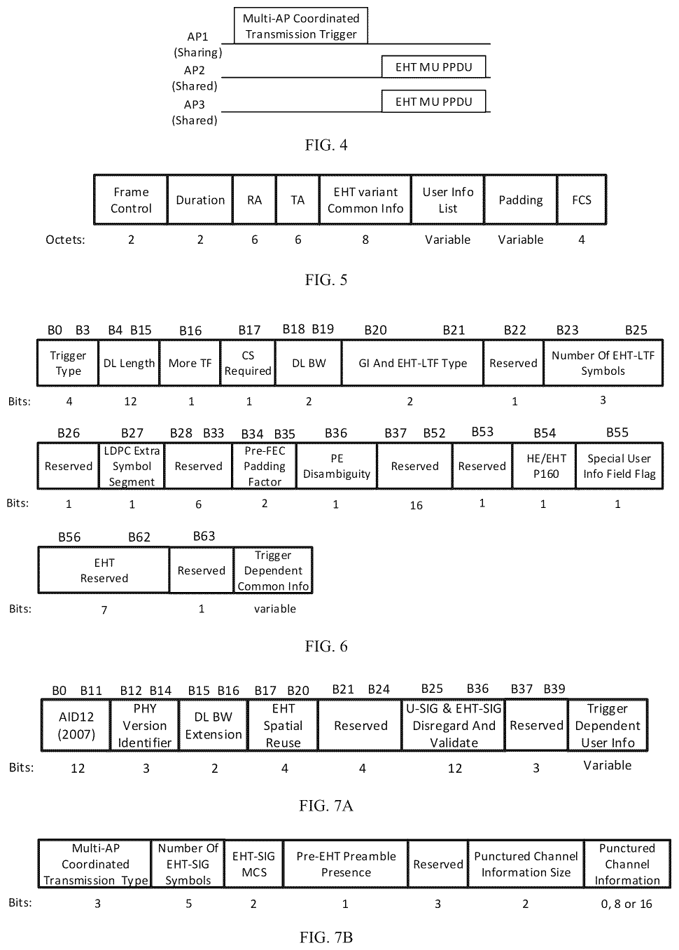

A sharing AP may transmit a Multi-AP Coordinated Transmission Trigger frame to solicit EHT MU PPDU transmissions from one or more shared APs in a multi-AP coordinated DL transmission. Within SIFS after receiving the Multi-AP Coordinated Transmission Trigger frame, the shared APs simultaneously transmit respective EHT MU PPDUs to one or more STAs. If the sharing AP participate in the multi-AP coordinated DL transmission, within SIFS after transmitting the Multi-AP Coordinated Transmission Trigger frame, the sharing AP also transmits its own EHT MU PPDU. FIG. 4 illustrates an example multi-AP coordinated DL transmission. AP1, AP2 and AP3 belong to an AP candidate set; AP1 is the sharing AP which initiates the multi-AP coordinated DL transmission; and AP2 and AP3 are the shared APs which participate in the multi-AP coordinated DL transmission.

Multi-AP Coordinated Transmission Trigger frame is a variant of Trigger frame. An example format of the Multi-AP Coordinated Transmission Trigger frame format is illustrated in FIG. 5, which includes an EHT variant Common Info field and a User Info List field including a Special User Info field and one or more EHT variant User Info fields.

For a Multi-AP Coordinated Transmission Trigger frame, the TA field is set to a VBSSID of a VBSS or an AP candidate set related to a multi-AP coordinated DL transmission. If the Multi-AP Coordinated Transmission Trigger frame is used to solicit EHT MU PPDU transmission from a single shared AP, the RA field is set to the BSSID of the shared AP. If the Multi-AP Coordinated Transmission Trigger frame is used to solicit EHT MU PPDU transmissions from more than one shared APs, the RA field is set to a broadcast address. An example format of the EHT variant Common Info field is illustrated in FIG. 6. The Trigger Type subfield is set to a value in [9 15] (e.g., 9) to indicate the Multi-AP Coordinated Transmission variant of Trigger frame. The DL Length subfield indicates the value of the L-SIG LENGTH field of the solicited EHT MU PPDUs. The More TF subfield indicates whether or not a subsequent Multi-AP Coordinated Transmission Trigger frame is scheduled for transmission. The CS Required subfield is set to 1 to indicate that the shared APs are required to use ED to sense the medium and to consider the medium state and the NAV in determining whether or not to transmit the solicited EHT MU PPDUs. The CS Required subfield is set to 0 to indicate that the shared APs are not required to consider the medium state or the NAV in determining whether or not to transmit the solicited EHT MU PPDUs.

The GI And EHT-LTF Type subfield indicates the value of the GI+LTF Size subfield of the EHT-SIG field of the solicited EHT MU PPDUs, i.e., indicates the GI duration and EHT-LTF size for the solicited EHT MU PPDUs. It is set to 0 to indicate 2×EHT-LTF+0.8 us GI; set to 1 to indicate 2×EHT-LTF+1.6 us GI; set to 2 to indicate 4×EHT-LTF+0.8 us GI; and set to 3 to indicate 4×EHT-LTF+3.2 us GI. The Number Of EHT-LTF Symbols subfield indicates the value of the Number Of EHT-LTF Symbols subfield of the EHT-SIG field of the solicited EHT MU PPDUs, i.e., indicates the number of EHT-LTF symbols in the solicited EHT MU PPDUs. For example, the Number Of EHT-LTF Symbols subfield is set to 0 to indicate 1 EHT-LTF symbol; set to 1 to indicate 2 EHT-LTF symbols; set to 2 to indicate 4 EHT-LTF symbols; set to 3 to indicate 6 EHT-LTF symbols; set to 4 to indicate 8 EHT-LTF symbols; set to 5 to indicate 12 EHT-LTF symbols; and set to 6 to indicate 16 EHT-LTF symbols.

The LDPC Extra Symbol Segment subfield indicates the value of the LDPC Extra Symbol Segment subfield of the EHT-SIG field of the solicited EHT MU PPDUs, i.e., indicates the presence of a LDPC extra symbol segment in the solicited EHT MU PPDUs. It is set to 1 if a LDPC extra symbol segment is present in the solicited EHT MU PPDUs and set to 0 if a LDPC extra symbol segment is not present in the solicited EHT MU PPDUs. The Pre-FEC Padding Factor subfield indicates the value of the Pre-FEC Padding Factor subfield of the EHT-SIG field of the solicited EHT MU PPDUs, i.e., indicates a pre-FEC padding factor for the solicited EHT MU PPDUs. It is set to 0 to indicate a pre-FEC padding factor of 4; set to 1 to indicate a pre-FEC padding factor of 1; set to 2 to indicate a pre-FEC padding factor of 2; and set to 3 to indicate a pre-FEC padding factor of 3. The PE Disambiguity subfield indicates the value of the PE Disambiguity subfield of the EHT-SIG field of the solicited EHT MU PPDUs as defined in 36.3.14 of IEEE 802.11be D1.2. The HE/EHT P160 subfield is always set to 0, indicating that each of the solicited MU PPDUs in the primary 160 MHz channel is an EHT MU PPDU. The Special User Info Field Flag subfield is always set to 0, indicating that a Special User Info field is included in the Multi-AP Coordinated Transmission Trigger frame.

### Embodiment 5

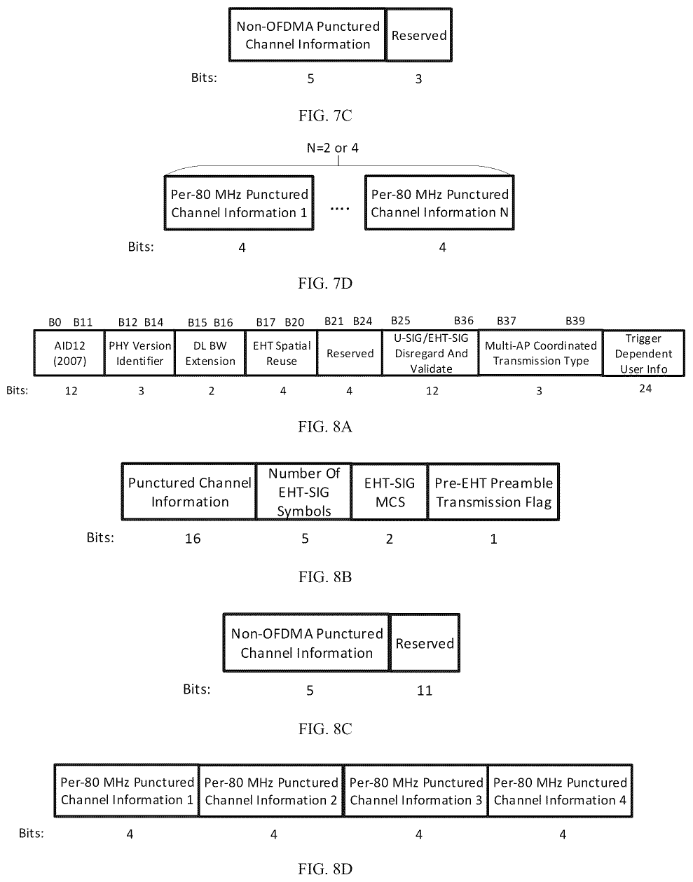

According to a fifth embodiment, an example format of the Special User Info field of a Multi-AP Coordinated Transmission Trigger frame is defined in FIG. 7A. The PHY Version Identifier subfield of the Special User Info field indicates the PHY version of the solicited MU PPDUs and is set to 0 for EHT. The DL BW subfield of the Common Info field along with the DL BW Extension subfield of the Special User Info field indicates a coordinated transmission bandwidth for the multi-AP coordinated DL transmission, which is the same as or within BSS operating channel width of the sharing AP. The DL BW Extension subfield is defined in Table 6.

TABLE 6

| DL BW | DL BW | Coordinated |
|---|---|---|
| subfield | Extension | transmission |
| value | subfield value | bandwidth (MHz) |
| 0 | 0 | 20 |
| 0 | 1-3 | reserved |
| 1 | 0 | 40 |
| 1 | 1-3 | reserved |
| 2 | 0 | 80 |
| 2 | 1-3 | reserved |
| 3 | 0 | reserved |
| 3 | 1 | 160 |
| 3 | 2 | 320-1 |
| 3 | 3 | 320-2 |

The EHT Spatial Reuse subfield of the Special User Info field carries the value to be included in the Spatial Reuse subfield of the EHT-SIG field of the solicited EHT MU PPDUs, i.e., indicates whether or not spatial reuse modes are allowed during the transmission of the solicited EHT MU PPDUs. It is set to a value from Table 27-22 of IEEE Std. 802.11ax-2021. The U-SIG/EHT-SIG Disregard and Validate subfield carries the value to be included in the Disregard and Validate subfields of the U-SIG field and the Common field for non-OFDMA transmission of the EHT-SIG field of the solicited EHT MU PPDUs. The mapping from the U-SIG/EHT-SIG Disregard and Validate subfield to bits in the U-SIG field and the Common field for non-OFDMA transmission of the EHT-SIG field for an EHT MU PPDU is defined in Table 7. For simplifying implementation, if one or more bits of the Disregard and Validate subfields of the U-SIG field and the Common field for non-OFDMA transmission of the EHT-SIG field of EHT MU PPDU are used for a certain signalling purpose, the corresponding bits of the U-SIG/EHT-SIG Disregard and Validate subfield of the Special User Info field are reserved or used for the same signalling purpose. For example, as illustrated in Table 7, if B25 of the U-SIG-1 field of EHT MU PPDU is used as a BSS/VBSS subfield which indicates whether the EHT MU PPDU is transmitted in a BSS or VBSS, B5 of the U-SIG/EHT-SIG Disregard and Validate subfield of the Special User Info field is reserved.

TABLE 7

| Bits of U-SIG/ | |
|---|---|
| EHT-SIG Disregard | U-SIG field and Common |
| And Validate subfield | field for non-OFDMA |
| of the Special User | transmission of EHT-SIG |
| Info field | field of EHT MU PPDU |
| B0-B4 | B20-B24 of the U-SIG-1 field |
| B5 | B25 of the U-SIG-1 field |
| B6 | B2 of the U-SIG-2 field |
| B7 | B8 of the U-SIG-2 field |
| B8-B11 | B13-B16 of the Common field for |
| | non-OFDMA transmission of EHT- |
| | SIG field |

According to the fifth embodiment, the Trigger Dependent User Info field of the Special User Info field is reserved and has a same size as the Trigger Dependent User Info field of the EHT variant User Info field. According to the fifth embodiment, the Trigger Dependent Common Info subfield is present in a Multi-AP Coordinated Transmission Trigger frame. An example format of the Trigger Dependent Common Info subfield is defined in FIG. 7B. The Multi-AP Coordinated Transmission Type subfield indicates the type of a multi-AP coordinated transmission. For example, the Multi-AP Coordinated Transmission Type subfield is set to a first value (e.g., 0) to indicate a multi-AP coordinated DL OFDMA transmission; set to a second value (e.g., 1) to indicate a multi-AP joint DL transmission; set to a third value (e.g., 2) to indicate a multi-AP coordinated UL OFDMA transmission; and set to a fourth value (e.g., 3) to indicate a multi-AP coordinated UL MU-MIMO transmission. The Number Of EHT-SIG Symbols subfield indicates the value of the Number Of EHT-SIG Symbols subfield of the U-SIG field of the solicited EHT MU PPDUs, i.e., indicates the number of EHT-SIG symbols in the solicited EHT MU PPDUs. It is set to a value that is the number of EHT-SIG symbols minus 1.

The EHT-SIG MCS subfield indicates the value of the EHT-SIG MCS subfield of the U-SIG field of the solicited EHT MU PPDUs, i.e., indicates the MCS used for modulating the EHT-SIG field of the solicited EHT MU PPDUs. It is set to 0 for EHT-MCS 0; set to 1 for EHT-MCS 1; set to 2 for EHT-MCS 3; and set to 3 for EHT-MCS 15. The Pre-EHT Preamble Presence subfield indicates whether pre-EHT modulated fields are present in the solicited EHT MU PPDUs. It is set to 1 to indicate that pre-EHT modulated fields are present in the solicited EHT MU PPDUs; and set to 0 to indicate that pre-EHT modulated fields are not present in the solicited EHT MU PPDUs. In case of a multi-AP coordinated DL OFDMA transmission, the Pre-EHT Preamble Presence subfield shall be set to indicate that pre-EHT modulated fields are present in the solicited EHT MU PPDUs. In case of a multi-AP coordinated joint DL transmission in which the sharing AP participates, the Pre-EHT Preamble Presence subfield may be set to indicate that pre-EHT modulated fields are not present in the solicited EHT MU PPDUs. In this case, the User Info List field includes no any User Info field addressed to any STA to which only the sharing AP will transmit a PSDU. As a result, the overhead of the Multi-AP Coordinated Transmission Trigger frame may be reduced. Furthermore, since each shared AP needs not to prepare pre-EHT modulated fields of the solicited EHT MU PPDU, padding in the Multi-AP Coordinated Transmission Trigger frame may be reduced or avoided.

The Punctured Channel Information Size subfield indicates the size of the Punctured Channel Information subfield. It is set to a first value (e.g., 0) to indicate that the Punctured Channel Information subfield is not present, which implies there is no any 20 MHz channels punctured in the coordinated transmission bandwidth; set to a second value (e.g., 1) to indicate that the Punctured Channel Information subfield has 8 bits; and set to a third value (e.g., 2) to indicate that the Punctured Channel Information subfield has 16 bits. The Punctured Channel Information Size subfield shall be set to indicate the Punctured Channel Information subfield is not present when the coordinated transmission bandwidth is 20 MHz or 40 MHz. A format of the Punctured Channel Information subfield depends on the type of the multi-AP coordinated DL transmission. In case of a multi-AP joint DL transmission, an example format of the Punctured Channel Information subfield is defined in FIG. 7C, where the Punctured Channel Information subfield includes a 5-bit Non-OFDMA Punctured Channel Information subfield as defined in Table 8. Alternatively, in case of a multi-AP joint DL transmission, the Punctured Channel Information subfield is not present; and the punctured channel information for the coordinated transmission bandwidth can be determined from an allocated RU or MRU as specified in the RU Allocation subfield and the PS160 subfield of each EHT variant User Info field.

TABLE 8

| Coordinated | | Puncturing | |
|---|---|---|---|
| Transmission | | Pattern (RU | Subfield |
| Bandwidth | Cases | or MRU Index) | value |
| 80 | Reserved | Reserved | 0 |
| | 20 MHz | [x 1 1 1] | 1 |
| | puncturing | (484 + 242- | |
| | | tone MRU 1) | |
| | | [1 x 1 1] | 2 |
| | | (484 + 242- | |
| | | tone MRU 2) | |
| | | [1 1 x 1] | 3 |
| | | (484 + 242- | |
| | | tone MRU 3) | |
| | | [1 1 1 x] | 4 |
| | | (484 + 242- | |
| | | tone MRU 4) | |
| | Reserved | Reserved | 5-31 |
| 160 | Reserved | Reserved | 0 |
| | 20 MHz | [x 1 1 1 1 1 1 1] | 1 |
| | puncturing | (996 + 484 + 242- | |
| | | tone MRU 1) | |
| | | [1 x 1 1 1 1 1 1] | 2 |
| | | (996 + 484 + 242- | |
| | | tone MRU 2) | |
| | | [1 1 x 1 1 1 1 1] | 3 |
| | | (996 + 484 + 242- | |
| | | tone MRU 3) | |
| | | [1 1 1 x 1 1 1 1] | 4 |
| | | (996 + 484 + 242- | |
| | | tone MRU 4) | |
| | | [1 1 1 1 x 1 1 1] | 5 |
| | | (996 + 484 + 242- | |
| | | tone MRU 1) | |
| | | [1 1 1 1 1 x 1 1] | 6 |
| | | (996 + 484 + 242- | |
| | | tone MRU 2) | |
| | | [1 1 1 1 1 1 x 1] | 7 |
| | | (996 + 484 + 242- | |
| | | tone MRU 3) | |
| | | [1 1 1 1 1 1 1 x] | 8 |
| | | (996 + 484 + 242- | |
| | | tone MRU 4) | |
| | 40 MHz | [x x 1 1 1 1 1 1] | 9 |
| | puncturing | (996 + 484- | |
| | | tone MRU 1) | |
| | | [1 1 x x 1 1 1 1] | 10 |
| | | (996 + 484- | |
| | | tone MRU 2) | |
| | | [1 1 1 1 x x 1 1] | 11 |
| | | (996 + 484- | |
| | | tone MRU 3) | |
| | | [1 1 1 1 1 1 x x] | 12 |
| | | (996 + 484- | |
| | | tone MRU 4) | |
| | Reserved | Reserved | 13-31 |
| 320 | Reserved | Reserved | 0 |
| | 40 MHz | [x 1 1 1 1 1 1 1] | 1 |
| | puncturing | (3 × 996 + 484- | |
| | | tone MRU 1) | |
| | | [1 x 1 1 1 1 1 1] | 2 |
| | | (3 × 996 + 484- | |
| | | tone MRU 2) | |
| | | [1 1 x 1 1 1 1 1] | 3 |
| | | (3 × 996 + 484- | |
| | | tone MRU 3) | |
| | | [1 1 1 x 1 1 1 1] | 4 |
| | | (3 × 996 + 484- | |
| | | tone MRU 4) | |
| | | [1 1 1 1 x 1 1 1] | 5 |
| | | (3 × 996 + 484- | |
| | | tone MRU 1) | |
| | | [1 1 1 1 1 x 1 1] | 6 |
| | | (3 × 996 + 484- | |
| | | tone MRU 2) | |
| | | [1 1 1 1 1 1 x 1] | 7 |
| | | (3 × 996 + 484- | |
| | | tone MRU 3) | |
| | | [1 1 1 1 1 1 1 x] | 8 |
| | | (3 × 996 + 484- | |
| | | tone MRU 4) | |
| | 80 MHz | [x x 1 1 1 1 1 1] | 9 |
| | puncturing | (3 × 996- | |
| | | tone MRU 1) | |
| | | [1 1 x x 1 1 1 1] | 10 |
| | | (3 × 996- | |
| | | tone MRU 2) | |
| | | [1 1 1 1 x x 1 1] | 11 |
| | | (3 × 996- | |
| | | tone MRU 3) | |
| | | [1 1 1 1 1 1 x x] | 12 |
| | | (3 × 996- | |
| | | tone MRU 4) | |
| | Both 40 MHz | [x x x 1 1 1 1 1] | 13 |
| | and 80 MHz | (2 × 996 + 484- | |
| | puncturing | tone MRU 7) | |
| | | [x x 1 x 1 1 1 1] | 14 |
| | | (2 × 996 + 484- | |
| | | tone MRU 8) | |
| | | [x x 1 1 x 1 1 1] | 15 |
| | | (2 × 996 + 484- | |
| | | tone MRU 9) | |
| | | [x x 1 1 1 x 1 1] | 16 |
| | | (2 × 996 + 484- | |
| | | tone MRU 10) | |
| | | [x x 1 1 1 1 x 1] | 17 |
| | | (2 × 996 + 484- | |
| | | tone MRU 11) | |
| | | [x x 1 1 1 1 1 x] | 18 |
| | | (2 × 996 + 484- | |
| | | tone MRU 12) | |
| | | [x 1 1 1 1 1 x x] | 19 |
| | | (2 × 996 + 484- | |
| | | tone MRU 1) | |
| | | [1 x 1 1 1 1 x x] | 20 |
| | | (2 × 996 + 484- | |
| | | tone MRU 2) | |
| | | [1 1 x 1 1 1 x x] | 21 |
| | | (2 × 996 + 484- | |
| | | tone MRU 3) | |
| | | [1 1 1 x 1 1 x x] | 22 |
| | | (2 × 996 + 484- | |
| | | tone MRU 4) | |
| | | [1 1 1 1 x 1 x x] | 23 |
| | | (2 × 996 + 484- | |
| | | tone MRU 5) | |
| | | [1 1 1 1 1 x x x] | 24 |
| | | (2 × 996 + 484- | |
| | | tone MRU 6) | |
| | reserved | reserved | 25-31 |

In case of a multi-AP coordinated DL OFDMA transmission, an example format of the Punctured Channel Information subfield is defined in FIG. 7D, where the Punctured Channel Information subfield includes N Per-80 MHz Punctured Channel Information subfields where N=2 or 4, each of which indicates punctured channel information for an 80 MHz frequency subblock. The Per-80 MHz Punctured Channel Information 1 to 4 subfields indicate punctured channel information for lowest, second lowest, third lowest and highest 80 MHz frequency subblocks, respectively. For each of the bits in a Per-80 MHz Punctured Channel Information subfield, a value of 0 indicates that the corresponding 20 MHz channel is punctured, and a value of 1 is used otherwise. The following allowed punctured patterns (B0-B3) are defined for an 80 MHz frequency subblock: 1111 (no puncturing), 0111, 1011, 1101, 1110, 0011, 1100, and 1001, where bits from left to right refer to 20 MHz channels in the order of increasing frequency.

The valid combinations between the coordinated transmission bandwidth, the multi-AP coordinated transmission type and the size of the Punctured Channel Information subfield are defined in Table 9.

TABLE 9

| | | Size of |
|---|---|---|
| | | Punctured |
| Coordinated | Multi-AP | Channel |
| Transmission | Coordinated | Information |
| Bandwidth (MHz) | Transmission Type | Subfield (bits) |
| 20/40 | Multi-AP joint DL transmission | 0 |
| 80/160/320 | Multi-AP joint DL transmission | 0 or 8 |
| 160 | Multi-AP coordinated DL OFDMA | 0 or 8 |
| | transmission | |
| 320 | Multi-AP coordinated DL OFDMA | 0 or 16 |
| | transmission | |

### Embodiment 6

According to a sixth embodiment, the Trigger Dependent Common Info subfield is not present in a Multi-AP Coordinated Transmission Trigger frame, resulting in reduced signalling overhead compared with the fifth embodiment. An example format of the Special User Info field according to the sixth embodiment is defined in FIG. 8A. An example format of the Trigger Dependent User Info subfield of the Special User Info field according to the sixth embodiment is defined in FIG. 8B. The subfields of the Special User Info field except the Punctured Channel information subfield in the sixth embodiment have the same definitions as their counterparts in the fifth embodiment. According to the sixth embodiment, a format of the Punctured Channel Information subfield depends on the type of the multi-AP coordinated DL transmission. In case of a multi-AP joint DL transmission, an example format of the Punctured Channel Information subfield according to the sixth embodiment is defined in FIG. 8C, where the Punctured Channel Information subfield includes a 5-bit Non-OFDMA Punctured Channel Information subfield as defined in Table 36-30 of IEEE 802.11be D1.2 except that the first column is renamed from “PPDU bandwidth” to “coordinated transmission bandwidth”. Alternatively, in case of a multi-AP joint DL transmission, the Punctured Channel Information subfield is reserved; and the punctured channel information for the coordinated transmission bandwidth can be determined from an allocated RU or MRU as specified in the RU Allocation subfield and the PS160 subfield of each EHT variant User Info field.

In case of a multi-AP coordinated DL OFDMA transmission, an example format of the Punctured Channel Information subfield is defined in FIG. 8D, where the Punctured Channel Information subfield includes four Per-80 MHz Punctured Channel Information subfields, each of which indicates punctured channel information for an 80 MHz frequency subblock. The Per-80 MHz Punctured Channel Information 1 to 4 subfields indicate punctured channel information for lowest, second lowest, third lowest and highest 80 MHz frequency subblocks, respectively. For each of the bits in a Per-80 MHz Punctured Channel Information subfield, a value of 0 indicates that the corresponding 20 MHz channel is punctured, and a value of 1 is used otherwise. The following allowed punctured patterns (B0-B3) are defined for an 80 MHz frequency subblock: 1111 (no puncturing), 0111, 1011, 1101, 1110, 0011, 1100, and 1001, where bits from left to right refer to 20 MHz channels in the order of increasing frequency. When the coordinated transmission bandwidth is 160 MHz, each of the Per-80 MHz Punctured Channel Information 3 subfield and Per-80 MHz Punctured Channel Information 4 subfield is reserved or set to all “0”.

### Embodiment 7

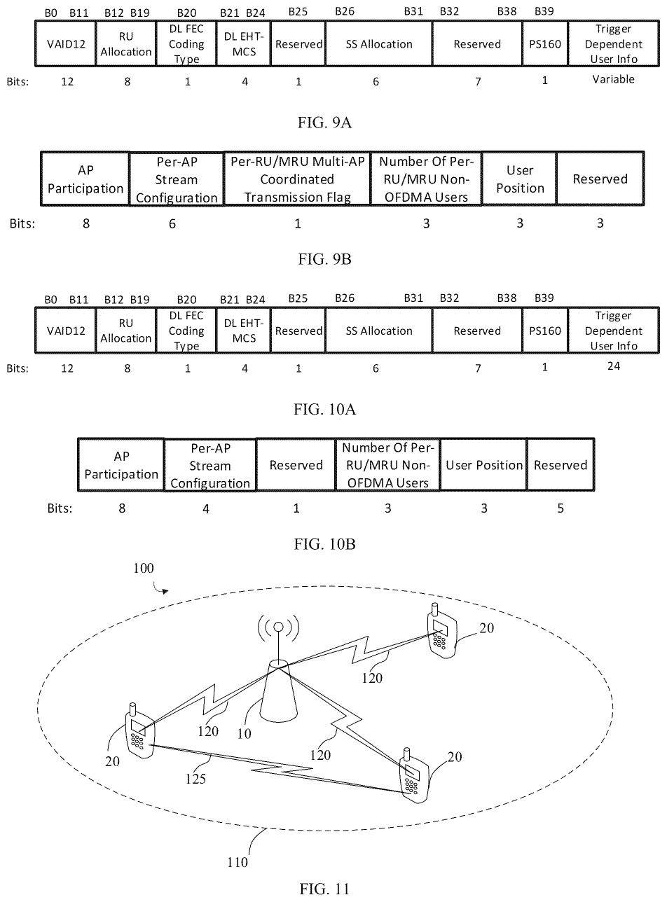

According to a seventh embodiment, an example format of EHT variant User Info field is defined in FIG. 9A. If the VAID12 subfield is set to a value in [1 2006], the EHT variant User Info field is addressed to a STA whose VAID is equal to the value in the VAID12 subfield. If the VAID12 subfield is 2046, then the remaining subfields in the EHT variant User Info field are reserved, except for the RU Allocation subfield and the PS160 subfield, which along with the DL BW subfield of the EHT variant Common Info field and the DL BW Extension subfield of the Special User Info field indicates the RU or MRU location of the unallocated RU or MRU. The RU Allocation subfield and the PS160 subfield of the EHT variant User Info field along with the DL BW subfield of the EHT variant Common Info field and the DL BW Extension subfield of the Special User Info field identify the size and location of a RU or MRU allocated to the STA addressed by this EHT variant User Info field. The mapping of B7-B1 of the RU Allocation subfield along with the settings of B0 of the RU Allocation subfield and PS160 subfield are defined in Table 9-29j1 of IEEE 802.11be D1.2.

The DL FEC Coding Type subfield indicates the code type for the STA addressed by this EHT variant User Info field. It is set to 0 to indicate BCC and set to 1 to indicate LDPC. The DL EHT-MCS subfield indicates the EHT-MCS for the STA addressed by this EHT variant User Info field. The encoding of the DL EHT-MCS subfield is defined in Clause 36.5 of IEEE 802.11be D1.2. The SS Allocation subfield defines the spatial streams transmitted by one or more shared APs to the STA addressed by this EHT variant User Info field. The format of the SS Allocation subfield depends on the number of users multiplexed on the RU or MRU as specified in the RU Allocation subfield and the RU Allocation subfield. When more than one user are multiplexed on the RU or MRU as specified in the RU Allocation subfield and the PS160 subfield, the SS Allocation subfield includes a 4-bit Starting Spatial Stream subfield and a 2-bit Number Of Spatial Streams subfield. The Starting Spatial Stream subfield indicates the starting spatial stream (SSN) and is set to the starting spatial stream minus 1. The Number of Spatial Streams subfield indicates the number of spatial streams (N_{SS}) where 4≥N_{SS}≥1, and is set to the number of spatial streams minus 1. When only a single user is multiplexed on the RU or MRU as specified in the RU Allocation subfield and the PS160 subfield, the SS Allocation subfield includes a 4-bit Number of Spatial Streams subfield. The Number of Spatial Streams subfield indicates the number of spatial streams (N_{SS}) where 16≥N_{SS}≥1, and is set to the number of spatial streams minus 1.

An example format of the Trigger Dependent User Info field according to the seventh embodiment is defined in FIG. 9B. The AP Participation subfield indicates one or more shared APs in an AP candidate set which will transmit respective PSDUs to the STA addressed by this EHT variant User Info field, where the AP candidate set can be determined according to the TA address of the Multi-AP Coordinated Transmission Trigger frame. A value of 1 in bit position i of the AP Participation subfield indicates that a shared AP with AP ID i will transmit a PSDU to the STA. A value of 0 in bit position i of the AP Participation subfield indicates that a shared AP with AP ID i will not transmit a PSDU to the STA. The shared APs that will transmit respective PSDUs to the STA are consecutively numbered in an increasing order of AP ID, starting with 1. For example, if two shared APs with AP IDs of 2 and 4 will transmit respective PSDUs to the STA, the shared AP with AP ID=2 is numbered AP1, while the shared AP with AP ID=4 is numbered AP2. The number of shared APs which will transmit respective PSDUs to the STA is denoted by N_{AP}, where 1≤N_{AP}≤3. That is to say, the number of bits in the AP Participation subfield set to 1 is up to 3. It should be noted that a sharing AP may also transmit a PSDU to the STA addressed by this EHT variant User Info field at its own discretion. However, when N_{AP}=3, the sharing AP does not transmit a PSDU to the STA addressed by this EHT variant User Info field since at most three APs can transmit respective PSDUs to a same STA.

The Per-AP Stream Configuration subfield indicates a number of spatial streams (N_{SS,k}, k=1, 2, . . . , N_{AP}) for each of the shared APs that will transmit respective PSDUs to the STA. When more than one user are multiplexed on the RU or MRU as specified in the RU Allocation subfield and the PS160 subfield, an example encoding of the Per-AP Stream Configuration subfield is defined in Table 10.

TABLE 10

| | |
|---|---|
| Per-AP Stream | |
| Configuration | N_{SS, k} for AP k |

| subfield value | k = 1 | k = 2 | k = 3 |
|---|---|---|---|
| 0 | 1 | N_{SS} − N_{SS, 1} | |
| 1 | 2 | N_{SS} − N_{SS, 1} | |
| 2 | 3 | 1 | |
| 3 | 1 | 1 | N_{SS} − N_{SS, 1} − N_{SS, 2} |
| 4 | 2 | 1 | 1 |
| 5 | 1 | 2 | 1 |

| | |
|---|---|
| 6-62 | reserved |
| 63 | Same spatial streams for all APs |

The Per-AP Stream Configuration subfield is set to a first value (e.g. 15) to indicate that the shared APs transmit one or more same spatial streams as indicated in the SS Allocation subfield to the STA. The Per-AP Stream Configuration subfield is set to a value which is different from the first value to indicate that the shared APs transmit different spatial streams to the STA. In this case, the starting stream number (SSN₁) for a first shared AP that will transmit a PSDU to the STA is SSN. When N_{AP}≥2, the starting stream number (SSNₖ, k=2, . . . , N_{AP}) for each of the remaining shared APs that will transmit respective PSDUs to the STA is:

$${SSN}_{k} = SSN + {\sum }_{i = 1}^{k - 1} {N}_{SS , i} . \qquad ( 1 )$$

When only a single user is multiplexed on the RU or MRU as specified in the RU Allocation subfield and the PS160 subfield, an example encoding of the Per-AP Stream Configuration subfield is defined in Table 11.

TABLE 11

| | |
|---|---|
| Per-AP Stream | |
| Configuration | N_{SS, k} for AP k |

| subfield value | k = 1 | k = 2 | k = 3 |
|---|---|---|---|
| 0 | 1 | N_{SS} − N_{SS, 1} | |
| 1 | 2 | N_{SS} − N_{SS, 1} | |
| 2 | 3 | N_{SS} − N_{SS, 1} | |
| 3 | 4 | N_{SS} − N_{SS, 1} | |
| 4 | 5 | N_{SS} − N_{SS, 1} | |
| 5 | 6 | N_{SS} − N_{SS, 1} | |
| 6 | 7 | N_{SS} − N_{SS, 1} | |
| 7 | 8 | N_{SS} − N_{SS, 1} | |
| 8 | 1 | 1 | N_{SS} − N_{SS, 1} − N_{SS, 2} |
| 9 | 2 | 2 | N_{SS} − N_{SS, 1} − N_{SS, 2} |
| 10 | 3 | 3 | N_{SS} − N_{SS, 1} − N_{SS, 2} |
| 11 | 4 | 4 | N_{SS} − N_{SS, 1} − N_{SS, 2} |
| 12 | 5 | 5 | N_{SS} − N_{SS, 1} − N_{SS, 2} |
| 13 | 6 | 6 | N_{SS} − N_{SS, 1} − N_{SS, 2} |
| 14 | 1 | 2 | N_{SS} − N_{SS, 1} − N_{SS, 2} |
| 15 | 2 | 3 | N_{SS} − N_{SS, 1} − N_{SS, 2} |
| 16 | 3 | 4 | N_{SS} − N_{SS, 1} − N_{SS, 2} |
| 17 | 4 | 5 | N_{SS} − N_{SS, 1} − N_{SS, 2} |
| 18 | 5 | 6 | N_{SS} − N_{SS, 1} − N_{SS, 2} |
| 19 | 2 | 1 | N_{SS} − N_{SS, 1} − N_{SS, 2} |
| 20 | 3 | 2 | N_{SS} − N_{SS, 1} − N_{SS, 2} |
| 21 | 4 | 3 | N_{SS} − N_{SS, 1} − N_{SS, 2} |
| 22 | 5 | 4 | N_{SS} − N_{SS, 1} − N_{SS, 2} |
| 23 | 6 | 5 | N_{SS} − N_{SS, 1} − N_{SS, 2} |
| 24 | 1 | 3 | N_{SS} − N_{SS, 1} − N_{SS, 2} |
| 25 | 2 | 4 | N_{SS} − N_{SS, 1} − N_{SS, 2} |
| 26 | 3 | 5 | N_{SS} − N_{SS, 1} − N_{SS, 2} |
| 27 | 4 | 6 | N_{SS} − N_{SS, 1} − N_{SS, 2} |
| 28 | 5 | 7 | N_{SS} − N_{SS, 1} − N_{SS, 2} |
| 29 | 6 | 8 | N_{SS} − N_{SS, 1} − N_{SS, 2} |
| 30 | 3 | 1 | N_{SS} − N_{SS, 1} − N_{SS, 2} |
| 31 | 4 | 2 | N_{SS} − N_{SS, 1} − N_{SS, 2} |
| 32 | 5 | 3 | N_{SS} − N_{SS, 1} − N_{SS, 2} |
| 33 | 6 | 4 | N_{SS} − N_{SS, 1} − N_{SS, 2} |
| 34 | 7 | 5 | N_{SS} − N_{SS, 1} − N_{SS, 2} |
| 35 | 8 | 6 | N_{SS} − N_{SS, 1} − N_{SS, 2} |

| | |
|---|---|
| 36-62 | reserved |
| 63 | Same spatial streams for all APs |

The Number of Per-RU/MRU Non-OFDMA Users subfield indicates a number of STAs that are multiplexed on a same RU or MRU as specified in the RU Allocation and PS160 subfields; and is set to the number of STAs minus one; and the User Position subfield indicates a position of the STA addressed by this EHT variant User Info field amongst all the STAs that are multiplexed on the same RU or MRU. It is set to 0 to indicate that the STA addressed by this EHT variant User Info field is in a first place among all the STA multiplexed on the same RU or MRU; set to 1 to indicate that the STA addressed by this EHT variant User Info field is in a second place among all the STA multiplexed on the same RU or MRU; and so on. According to the seventh embodiment, EHT variant User Info fields addressed to all STAs multiplexed on a same RU or MRU are placed together in the User Info List field of a Multi-AP Coordinated Transmission Trigger frame. By doing so, when a shared AP identifies an EHT variant User Info field addressed to a STA to which it will transmits a PSDU, it may be able to easily identify EHT variant User Info fields addressed to one or more other STAs multiplexed on a same RU or MRU as the STA. It should be noted that when multiple APs transmit respective EHT MU PPDUs on a same RU or MRU, each of the APs needs to know transmission parameters for each of the STAs multiplexed on the RU or MRU so that the EHT-SIG field of the transmitted EHT MU PPDUs can be made to be exactly the same.

The Per-RU/MRU Multi-AP Coordinated Transmission Flag subfield indicates whether multiple APs will transmit respective EHT MU PPDUs on a same RU or MRU as specified in the RU Allocation and PS160 subfield. It is set to a first value (e.g., 0) to indicate that only a single AP will transmit an EHT MU PPDU on the RU or MRU; and set to a second value (e.g. 1) to indicate that multiple APs will transmit respective EHT MU PPDUs on the same RU or MRU. When the value of N_{AP} determined from the Per-User AP Participation subfield is larger than 1, the Per-RU/MRU Multi-AP Coordinated Transmission Flag subfield shall be set to indicate that multiple APs will transmit respective EHT MU PPDUs on the same RU or MRU. In case of a multi-AP joint DL transmission, the Per-RU/MRU Multi-AP Coordinated Transmission Flag subfield of each EHT variant User Info field shall be set to indicate that multiple APs will transmit respective EHT MU PPDUs on the same RU or MRU. When the Per-RU/MRU Multi-AP Coordinated Transmission Flag subfield is set to indicate that only a single AP will transmit an EHT MU PPDU on a RU or MRU as specified in the RU Allocation and PS160 subfields, the AID12 subfield, DL FEC Coding Type subfield, DL EHT-MCS subfield, SS Allocation subfield, Number of Non-OFDMA Users subfield and User Position subfield in the EHT variant User Info field may be reserved. In this case, the only AP as specified in the AP Participation subfield is able to determine how to transmit an EHT MU PPDU (e.g., intended users and transmission parameters for each of the intended users) on the RU or MRU at its own discretion.

### Example 1

In a first example, assume that two shared APs with AP ID=1 and AP ID=3 in an AP candidate set participate in a multi-AP joint DL transmission to four STAs (STA1, STA2, STA3 and STA4) in a 320 MHz channel with lowest 80 MHz channel punctured. In particular, the shared AP with AP ID=1 transmits an EHT MU PPDU carrying a first stream to STA1, a third stream to STA2, and a fifth stream and a sixth stream to STA3; while the shared AP with AP ID=3 transmits an EHT MU PPDU carrying a second stream to STA1, a fourth stream to STA2, and a seventh stream and an eighth stream to STA4. According to the seventh embodiment, in this example, a Multi-AP Coordinated Transmission Trigger frame includes four EHT variant User Info fields addressed to four STAs, respectively. For each of the four EHT variant User Info fields, the PS160 subfield is set to 0, and B0 and B1-B7 of the RU Allocation subfield are set to 0 and 104, respectively. For a first EHT variant User Info field addressed to STA1, the Starting Spatial Stream subfield is set to 0, the Number Of Spatial Streams subfield is set to 2, the AP Participation subfield is set to 01010000, the Per-AP Stream Configuration subfield is set to 0, the Per-RU/MRU Multi-AP Coordinated Transmission Flag subfield is set to 1, the Number Of Per-RU/MRU Non-OFDMA Users subfield is set to 3, and the User Position subfield is set to 0. For a second EHT variant User Info field addressed to STA2, the Starting Spatial Stream subfield is set to 2, the Number Of Spatial Streams subfield is set to 2, the AP Participation subfield is set to 01010000, the Per-AP Stream Configuration subfield is set to 0, the Per-RU/MRU Multi-AP Coordinated Transmission Flag subfield is set to 1, the Number Of Per-RU/MRU Non-OFDMA Users subfield is set to 3, and the User Position subfield is set to 1. For a third EHT variant User Info field addressed to STA3, the Starting Spatial Stream subfield is set to 4, the Number Of Spatial Streams subfield is set to 2, the AP Participation subfield is set to 01000000, the Per-RU/MRU Multi-AP Coordinated Transmission Flag subfield is set to 1, the Number Of Per-RU/MRU Non-OFDMA Users subfield is set to 3, and the User Position subfield is set to 2. For a fourth EHT variant User Info field addressed to STA4, the Starting Spatial Stream subfield is set to 6, the Number Of Spatial Streams subfield is set to 2, the AP Participation subfield is set to 00010000, the Per-RU/MRU Multi-AP Coordinated Transmission Flag subfield is set to 1, the Number Of Per-RU/MRU Non-OFDMA Users subfield is set to 3, and the User Position subfield is set to 3.

### Example 2

In a second example, assume that two shared APs with AP ID=1 and AP ID=3 in an AP candidate set participate in a multi-AP coordinated DL OFDMA transmission in a 320 MHZ channel. In particular, the shared AP with AP ID=1 transmits a first EHT MU PPDU in a primary 160 MHz channel; while the shared AP with AP ID=3 transmits a second EHT MU PPDU in a secondary 160 MHz channel. How the first and second EHT MU PPDUs are transmitted is determined by the shared APs with AP ID=1 and AP ID=3 at their respective discretions. According to the seventh embodiment, in this example, a Multi-AP Coordinated Transmission Trigger frame includes two EHT variant User Info fields corresponding to the primary and secondary 160 MHz channels, respectively. For a first EHT variant User Info field corresponding to the primary 160 MHz channel, the PS160 subfield is set to 1, B0 of the RU Allocation subfield is set to 1, B1-B7 of the RU Allocation subfield is set to 68, the AP Participation subfield is set to 01000000, and the Per-RU/MRU Multi-AP Coordinated Transmission Flag subfield is set to 0. For a second EHT variant User Info field corresponding to the secondary 160 MHz channel, the PS160 subfield is set to 0, B0 of the RU Allocation subfield is set to 1, B1-B7 of the RU Allocation subfield is set to 68, the AP Participation subfield is set to 00010000, and the Per-RU/MRU Multi-AP Coordinated Transmission Flag subfield is set to 0.

### Example 3

In a third example, assume that three shared APs with AP ID=1, AP ID=2 and AP ID=3 in an AP candidate set participate in a multi-AP coordinated DL OFDMA transmission in a 320 MHz channel. In particular, the shared AP with AP ID=1 transmits a first EHT MU PPDU in a primary 160 MHz channel; while the shared AP with AP ID=2 transmits a second EHT MU PPDU carrying a first stream to STA1 and a third stream and a fourth stream to STA2; and the shared AP with AP ID=3 transmits a third EHT MU PPDU carrying a second stream to STA1 in a secondary 160 MHz channel. How the first EHT MU PPDU is transmitted is determined by the shared AP with AP ID=1 at its own discretion. According to the seventh embodiment, in this example, a Multi-AP Coordinated Transmission Trigger frame includes three EHT variant User Info fields. For a first EHT variant User Info field corresponding to the primary 160 MHz channel, the PS160 subfield is set to 1, B0 of the RU Allocation subfield is set to 1, B1-B7 of the RU Allocation subfield is set to 68, the AP Participation subfield is set to 01000000, and the Per-RU/MRU Multi-AP Coordinated Transmission Flag subfield is set to 0. For a second EHT variant User Info field addressed to STA1, the Starting Spatial Stream subfield is set to 0, the Number Of Spatial Streams subfield is set to 2, the AP Participation subfield is set to 00110000, the Per-AP Stream Configuration subfield is set to 0, the Per-RU/MRU Multi-AP Coordinated Transmission Flag subfield is set to 1, the Number Of Per-RU/MRU Non-OFDMA Users subfield is set to 1, and the User Position subfield is set to 0. For a third EHT variant User Info field addressed to STA2, the Starting Spatial Stream subfield is set to 2, the Number Of Spatial Streams subfield is set to 2, the AP Participation subfield is set to 00100000, the Per-RU/MRU Multi-AP Coordinated Transmission Flag subfield is set to 1, the Number Of Per-RU/MRU Non-OFDMA Users subfield is set to 1, and the User Position subfield is set to 1. For the second or third EHT variant User Info field, the PS160 subfield is set to 0, B0 of the RU Allocation subfield is set to 1, and B1-B7 of the RU Allocation subfield is set to 68.

### Embodiment 8

According to an eighth embodiment, an example format of the EHT variant User Info field is defined in FIG. 10A, and an example format of the Trigger Dependent User Info field is defined in FIG. 10B. According to the eighth embodiment, the value of the VAID12 subfield of EHT variant User Info field is used to indicate whether multiple APs will transmit respective EHT MU PPDUs on a RU or MRU as specified in the RU Allocation subfield and the PS160 subfield. A VAID equal to a first value (e.g., 2006) in [1 2006] shall not be assigned to any STA. The VAID12 subfield of EHT variant User Info field is set to the first value in [1 2006] to indicate that only a single shared AP will transmit an EHT MU PPDU on a RU or MRU as specified in the RU Allocation subfield and the PS160 subfield. The VAID12 subfield of EHT variant User Info field is set to a value in [1 2006] which is not equal to the first value to indicate that multiple AP will transmit an EHT MU PPDU on a RU or MRU as specified in the RU Allocation subfield and the PS160 subfield. In this case, the value of the VAID12 subfield of EHT variant User Info field also indicates a STA whose VAID is equal to the value in the VAID12 subfield. When the VAID12 subfield of EHT variant User Info field is set to the first value in [1 2006], the remaining subfields in the EHT variant User Info field are reserved, except for the RU Allocation subfield, the PS160 subfield and the AP Participation subfield. The RU Allocation subfield and the PS160 subfield together with the DL BW subfield of the EHT variant Common Info field and the DL BW Extension subfield of the Special User Info field indicate the size and location of a RU or MRU allocated to a single shared AP; and the AP Participation subfield indicates the shared AP.

### Example 4

In a fourth example, assume that two shared APs with AP ID=1 and AP ID=3 in an AP candidate set participate in a multi-AP coordinated DL OFDMA transmission in a 320 MHZ channel. In particular, the shared AP with AP ID=1 transmits a first EHT MU PPDU in a primary 160 MHz channel; while the shared AP with AP ID=3 transmits a second EHT MU PPDU in a secondary 160 MHz channel. How the first and second EHT MU PPDUs are transmitted is determined by the shared APs with AP ID=1 and AP ID=3 at their respective discretions. According to the eighth embodiment, in this example, a Multi-AP Coordinated Transmission Trigger frame includes two EHT variant User Info fields corresponding to the primary and secondary 160 MHz channels, respectively. For a first EHT variant User Info field corresponding to the primary 160 MHz channel, the VAID12 subfield is set to the first value (e.g., 2006), the PS160 subfield is set to 1, B0 of the RU Allocation subfield is set to 1, B1-B7 of the RU Allocation subfield is set to 68, and the AP Participation subfield is set to 01000000. For a second EHT variant User Info field corresponding to the secondary 160 MHz channel, the VAID12 subfield is set to the first value (e.g., 2006), the PS160 subfield is set to 0, B0 of the RU Allocation subfield is set to 1, B1-B7 of the RU Allocation subfield is set to 68, and the AP Participation subfield is set to 00010000.

### Example 5

In a fifth example, assume that three shared APs with AP ID=1, AP ID=2 and AP ID=3 in an AP candidate set participate in a multi-AP coordinated DL OFDMA transmission in a 320 MHz channel. In particular, the shared AP with AP ID=1 transmits a first EHT MU PPDU in a primary 160 MHz channel; while the shared AP with AP ID=2 transmits a second EHT MU PPDU carrying a first stream to STA1 and a third stream and a fourth stream to STA2; and the shared AP with AP ID=3 transmits a third EHT MU PPDU carrying a second stream to STA1 in a secondary 160 MHz channel. How the first EHT MU PPDU is transmitted is determined by the shared AP with AP ID=1 at its own discretion. According to the eighth embodiment, in this example, a Multi-AP Coordinated Transmission Trigger frame includes three EHT variant User Info fields. For a first EHT variant User Info field corresponding to the primary 160 MHz channel, the VAID12 subfield is set to the first value (e.g., 2006), the PS160 subfield is set to 1, B0 of the RU Allocation subfield is set to 1, B1-B7 of the RU Allocation subfield is set to 68, and the Per-User AP Participation subfield is set to 01000000. For a second EHT variant User Info field addressed to STA1, the Starting Spatial Stream subfield is set to 0, the Number of Spatial Streams subfield is set to 2, the AP Participation subfield is set to 00110000, the Per-AP Stream Configuration subfield is set to 0, the Number of Per-RU/MRU Non-OFDMA Users subfield is set to 1, and the User Position subfield is set to 0. For a third EHT variant User Info field addressed to STA2, the Starting Spatial Stream subfield is set to 2, the Number of Spatial Streams subfield is set to 2, the AP Participation subfield is set to 00100000, the Number Of Per-RU/MRU Non-OFDMA Users subfield is set to 1, and the User Position subfield is set to 1. For the second or third EHT variant User Info field, the PS160 subfield is set to 0, B0 of the RU Allocation subfield is set to 1, and B1-B7 of the RU Allocation subfield is set to 68.

FIG. 11 illustrates an example of a wireless communications system according to some embodiment of the present disclosure. The wireless communications system may be an example of a WLAN 100 (also known as a Wi-Fi network) (such as next generation, next big thing (NBT), ultra-high throughput (UHT) or EHT Wi-Fi network) configured in accordance with various aspects of the present disclosure. As described herein, the terms next generation, NBT, UHT, and EHT may be considered synonymous and may each correspond to a Wi-Fi network supporting a high volume of space-time-streams. The WLAN 100 may include an AP 10 and multiple associated STAs 20, which may represent devices such as mobile stations, personal digital assistant (PDAs), other handheld devices, netbooks, notebook computers, tablet computers, laptops, display devices (such as TVs, computer monitors, etc.), printers, etc. The AP 10 and the associated stations 20 may represent a basic service set (BSS) or an extended service set (ESS). The various STAs 20 in the network can communicate with one another through the AP 10. Also illustrated is a coverage area 110 of the AP 10, which may represent a basic service area (BSA) of the WLAN 100. An extended network station (not illustrated) associated with the WLAN 100 may be connected to a wired or wireless distribution system that may allow multiple APs 10 to be connected in an ESS or a VBSS.

In some embodiments, a STA 20 may be located in the intersection of more than one coverage area 110 and may associate with more than one AP 10. A single AP 10 and an associated set of STAs 20 may be referred to as a BSS. An ESS or a VBSS is a set of connected BSSs. A distribution system (not illustrated) may be used to connect APs 10 in an ESS or a VBSS. In some cases, the coverage area 110 of an AP 10 may be divided into sectors (also not illustrated). The WLAN 100 may include APs 10 of different types (such as a metropolitan area, home network, etc.), with varying and overlapping coverage areas 110. Two STAs 20 also may communicate directly via a direct wireless link 125 regardless of whether both STAs 20 are in the same coverage area 110. Examples of direct wireless links 120 may include Wi-Fi direct connections, Wi-Fi tunneled direct link setup (TDLS) links, and other group connections. STAs 20 and APs 10 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.1 lay, etc. In some other implementations, peer-to-peer connections or ad hoc networks may be implemented within the WLAN 100.

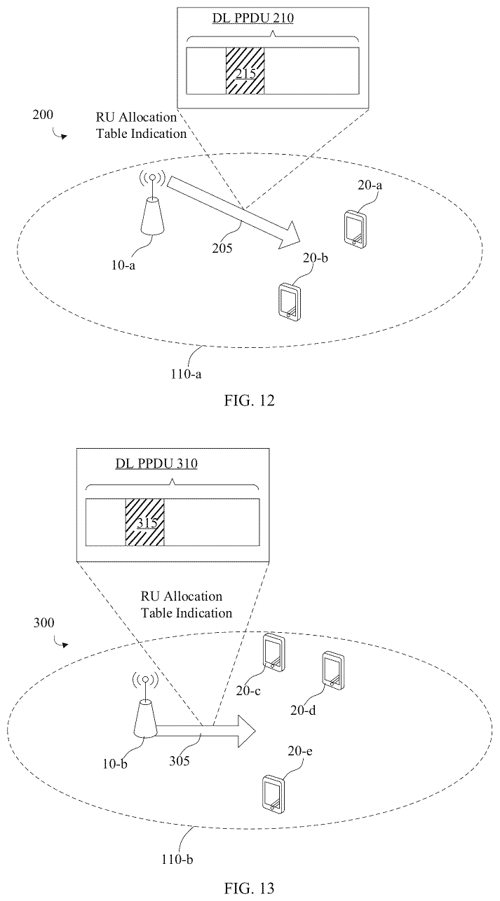

FIG. 12 illustrates an example of a wireless communications system according to another embodiment of the present disclosure. The wireless communications system 200 may be an example of a next generation or EHT Wi-Fi system and may include an AP 10-a and STAs 20-a and 20-b, and a coverage area 110-a, which may be examples of components described with respect to FIG. 12. The AP 10-a may transmit a DL PPDU 210 (e.g., EHT MU PPDU) including an RU allocation table indication 215 on the downlink 205 to the STAs 20.

In some implementations, a wireless communications system 200 may be a next generation Wi-Fi system (such as, an EHT system). In some implementations, wireless communications system 200 may also support multiple communications systems. For instance, wireless communications system 200 may support EHT communications and HE communications. In some implementations, the STA 20-a and the STA 20-b may be different types of STAs. For example, the STA 20-a may be an example of an EHT STA, while the STA 20-b may be an example of an HE STA. The STA 20-b may be referred to as a legacy STA.

In some instances, EHT communications may support a larger bandwidth than legacy communications. For instance, EHT communications may occur over an available bandwidth of 320 MHz, whereas legacy communications may occur over an available bandwidth of 160 MHZ. Additionally, EHT communications may support higher modulations than legacy communications. For instance, EHT communications may support 4K quadrature amplitude modulation (QAM), whereas legacy communications may support 1024 QAM. EHT communications may support a larger number of spatial streams than legacy systems. In one non-limiting illustrative example, EHT communications may support 16 spatial streams, whereas legacy communications may support 8 spatial streams. In some cases, EHT communications may occur a 2.4 GHz channel, a 5 GHz channel, or a 6 GHz channel in unlicensed spectrum.

FIG. 13 illustrates an example of a wireless communications system according to another embodiment of the present disclosure. The wireless communications system 300 may be an example of a post-EHT Wi-Fi system and may include an AP 10-b. AP 10-b may be an example of a post-EHT AP 10. The wireless communications system 300 may include HE STA 20-c, EHT STA 20-d, and post-EHT STA 20-c, and a coverage area 110-b, which may be examples of components described with respect to FIGS. 4 and 5. The AP 10-b may transmit a DL PPDU 310 including an RU allocation table indication 315 on the downlink 305 to the STAs 20. In some implementations, STAs 20 may be referred to as clients.

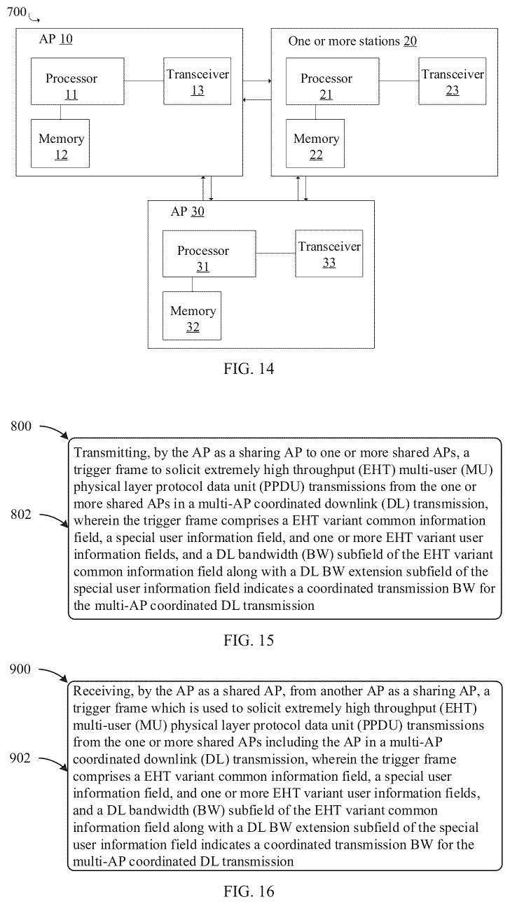

FIG. 14 illustrates one or more STAs 20, an AP 10, and an AP 30 of communication in a wireless communications system 700 according to some embodiment of the present disclosure. FIG. 14 illustrates that, the wireless communications system 700 includes an AP 10, an AP 30 and one or more STAs 20. The AP 10 may include a memory 12, a transceiver 13, and a processor 11 coupled to the memory 12, the transceiver 13. The AP 30 may include a memory 32, a transceiver 33, and a processor 31 coupled to the memory 32, the transceiver 33. The one or more STAs 20 may include a memory 22, a transceiver 23, and a processor 21 coupled to the memory 22, the transceiver 23. The processor 11, 21 or 31 may be configured to implement proposed functions, procedures and/or methods described in this description. Layers of radio interface protocol may be implemented in the processor 11, 21 or 31. The memory 12, 22 or 32 is operatively coupled with the processor 11, 21 or 31 and stores a variety of information to operate the processor 11, 21 or 31. The transceiver 13, 23 or 33 is operatively coupled with the processor 11, 21 or 31, and the transceiver 13, 23 or 33 transmits and/or receives a radio signal.

The processor 11, 21 or 31 may include application-specific integrated circuit (ASIC), other chipset, logic circuit and/or data processing device. The memory 12, 22 or 32 may include read-only memory (ROM), random access memory (RAM), flash memory, memory card, storage medium and/or other storage device. The transceiver 13, 23 or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22 or 32 and executed by the processor 11, 21 or 31. The memory 12, 22 or 32 can be implemented within the processor 11, 21 or 31 or external to the processor 11, 21 or 31 in which case those can be communicatively coupled to the processor 11, 21 or 31 via various means as is known in the art.

In some embodiments, the transceiver 13 is configured to transmit, by the AP 10 as a sharing AP to one or more stations shared APs 30, a trigger frame to solicit extremely high throughput (EHT) multi-user (MU) physical layer protocol data unit (PPDU) transmissions from the one or more shared APs in a multi-AP coordinated downlink (DL) transmission, wherein the trigger frame includes a EHT variant common information field, a special user information field, and one or more EHT variant user information fields, and a DL bandwidth (BW) subfield of the EHT variant common information field along with a DL BW extension subfield of the special user information field indicates a coordinated transmission BW for the multi-AP coordinated DL transmission. This can solve issues in the prior art, efficiently implement multi-AP downlink (DL) coordination in a multi-AP system, achieve extremely high throughput, provide good communication performance, and/or provide high reliability.

In some embodiments, the transceiver 33 is configured to receive, by the AP 30 as a shared AP, from the AP 10 as a sharing AP, a trigger frame which is used to solicit extremely high throughput (EHT) multi-user (MU) physical layer protocol data unit (PPDU) transmissions from one or more shared APs including the AP in a multi-AP coordinated downlink (DL) transmission, wherein the trigger frame includes a EHT variant common information field, a special user information field, and one or more EHT variant user information fields, and a DL bandwidth (BW) subfield of the EHT variant common information field along with a DL BW extension subfield of the special user information field indicates a coordinated transmission BW for the multi-AP coordinated DL transmission. This can solve issues in the prior art, efficiently implement multi-AP downlink (DL) coordination in a multi-AP system, achieve extremely high throughput, provide good communication performance, and/or provide high reliability.

In some embodiments, an access point (AP) 10 includes a transmitting unit (such as, the reference number 13 of FIG. 14) configured to transmit, to one or more stations (STAs), an extremely high throughput (EHT) multi-user (MU) physical layer protocol data unit (PPDU), wherein the EHT MU PPDU includes a basic service set (BSS)/virtual BSS (VBSS) color subfield in a universal signal (U-SIG) field, and the BSS/VBSS color subfield in the U-SIG field indicates a BSS color of the AP or a VBSS color of an AP candidate set of which the AP is a member.

In some embodiments, a station (STA) 20 includes a receiving unit (such as, the reference number 23 of FIG. 14) configured to receive, from an access point (AP), an extremely high throughput (EHT) multi-user (MU) physical layer protocol data unit (PPDU), wherein the EHT MU PPDU includes a basic service set (BSS)/virtual BSS (VBSS) color subfield in a universal signal (U-SIG) field, and the BSS/VBSS color subfield in the U-SIG field indicates a BSS color of the AP or a VBSS color of an AP candidate set of which the AP is a member.

FIG. 15 illustrates a wireless communication method 800 performed by an AP according to some embodiment of the present disclosure. In some embodiments, the method 800 includes: a block 802, transmitting, by the AP as a sharing AP to one or more shared APs, a trigger frame to solicit extremely high throughput (EHT) multi-user (MU) physical layer protocol data unit (PPDU) transmissions from the one or more shared APs in a multi-AP coordinated downlink (DL) transmission, wherein the trigger frame includes a EHT variant common information field, a special user information field, and one or more EHT variant user information fields, and a DL bandwidth (BW) subfield of the EHT variant common information field along with a DL BW extension subfield of the special user information field indicates a coordinated transmission BW for the multi-AP coordinated DL transmission. This can solve issues in the prior art, efficiently implement multi-AP downlink (DL) coordination in a multi-AP system, achieve extremely high throughput, provide good communication performance, and/or provide high reliability.

FIG. 16 illustrates a wireless communication method 900 performed by an AP according to some embodiment of the present disclosure. In some embodiments, the method 900 includes: a block 902, receiving, by the AP as a shared AP, from another AP as a sharing AP, a trigger frame which is used to solicit extremely high throughput (EHT) multi-user (MU) physical layer protocol data unit (PPDU) transmissions from one or more shared APs including the AP in a multi-AP coordinated downlink (DL) transmission, wherein the trigger frame includes a EHT variant common information field, a special user information field, and one or more EHT variant user information fields, and a DL bandwidth (BW) subfield of the EHT variant common information field along with a DL BW extension subfield of the special user information field indicates a coordinated transmission BW for the multi-AP coordinated DL transmission. This can solve issues in the prior art, efficiently implement multi-AP downlink (DL) coordination in a multi-AP system, achieve extremely high throughput, provide good communication performance, and/or provide high reliability.

In some embodiments, a TA field of the trigger frame is set to a virtual basic service set identifier (VBSSID) of a VBSS related to the multi-AP coordinated DL transmission. In some embodiments, if the one or more shared APs includes a single AP, an RA field of the trigger frame is set to a BSS identifier (BSSID) of the AP; or otherwise, the RA field of the trigger frame is set to a broadcast address. In some embodiments, the EHT variant common information field includes a DL length subfield which indicates a value of a non-HT signal field (L-SIG) length field of solicited EHT MU PPDUs. In some embodiments, the EHT variant common information field includes a CS required subfield which indicates whether the one or more shared APs are required to use an energy detect (ED) to sense a medium and to consider a medium state and a network allocation vector (NAV) in determining whether or not to transmit solicited EHT MU PPDUs.

In some embodiments, the EHT variant common information field includes a guard interval (GI) and EHT long training field (EHT-LTF) type subfield and a number of EHT-LTF symbols subfield which indicate values of the GI and EHT-LTF type subfield and the number of EHT-LTF symbols subfield of an EHT-SIG field of solicited EHT MU PPDUs, respectively. In some embodiments, the EHT variant common information field includes a low density parity code (LDPC) extra symbol segment subfield, a pre-forward error correction (pre-FEC) padding factor subfield and a packet extension field (PE) disambiguity subfield which indicate values of the LDPC extra symbol segment subfield, the pre-FEC padding factor subfield and the PE disambiguity subfield of an EHT-SIG field of solicited EHT MU PPDUs, respectively. In some embodiments, the special user information field includes an EHT spatial reuse subfield which carries a value to be included in a spatial reuse subfield of an EHT-SIG field of solicited EHT MU PPDUs.

In some embodiments, the special user information field or the EHT variant common information field includes a multi-AP coordinated transmission type subfield which indicates a type of the multi-AP coordinated DL transmission. In some embodiments, the special user information field or the EHT variant common information field includes a number of EHT-SIG symbols subfield and an EHT-SIG MCS subfield which indicate values of the number of EHT-SIG symbols subfield and the EHT-SIG modulation and coding scheme (MCS) subfield of a U-SIG field of solicited EHT MU PPDUs, respectively. In some embodiments, the special user information field or the EHT variant common information field includes a U-SIG/EHT-SIG disregard and validate subfield which indicates a value of a disregard and validate subfields of a U-SIG field and a common field for non-orthogonal frequency division multiple access (OFDMA) transmission of an EHT-SIG field of solicited EHT MU PPDUs.

In some embodiments, the special user information field or the EHT variant common information field includes a pre-EHT preamble presence subfield which indicates whether pre-EHT modulated fields are present in solicited EHT MU PPDUs. In some embodiments, the common information field includes a punctured channel information subfield which indicates punctured channel information for solicited EHT MU PPDUs; and a punctured channel information size subfield, which indicates a size of the punctured channel information subfield of 0 bits, 8 bits or 16 bits. In some embodiments, an absence of the punctured channel information subfield indicates that no any 20 MHz channel is punctured from a coordinated transmission bandwidth. In some embodiments, the punctured channel information subfield of 8 bits includes a 5-bit subfield which indicates punctured channel information for the coordinated transmission bandwidth. In some embodiments, the punctured channel information subfield of 8 bits or 16 bits includes two or four 4-bit subfields, each of which indicates punctured channel information for an 80 MHz frequency subblock. In some embodiments, the special user information field includes a 16-bit punctured channel information subfield that indicates punctured channel information for solicited EHT MU PPDUs. In some embodiments, the punctured channel information subfield includes a 5-bit subfield which indicates punctured channel information for the coordinated transmission bandwidth. In some embodiments, the punctured channel information subfield includes four 4-bit subfields, each of which indicates punctured channel information for an 80 MHz frequency subblock. In some embodiments, each of two of the four 4-bits subfields corresponding to third lowest and highest 80 MHz frequency subblocks is reserved or set to 0 when the coordinated transmission bandwidth is 160 MHZ.

In some embodiments, each EHT variant user information field includes a per-resource unit (RU)/multiple resource unit (MRU) multi-AP coordinated transmission flag subfield which indicates whether multiple APs transmit respective EHT MU PPDUs on a same RU or MRU; and a VAID12 subfield which indicates a STA whose VAID equal to the value of the VAID12 subfield. In some embodiments, each EHT variant user information field includes a VAID12 subfield which indicates whether multiple APs transmit respective EHT MU PPDUs on a same RU or MRU. In some embodiments, the VAID12 subfield is set to a first value in [1 2006] to indicate that only a single AP transmits an EHT MU PPDU on the RU or MRU; and set to a value in [1 2006] which is not equal to a first value to indicate multiple APs transmit respective EHT MU PPDUs on the RU or MRU and indicate a STA whose VAID equal to a value of the VAID12 subfield. In some embodiments, each EHT variant user information field includes a SS allocation subfield, whose format depends on a number of STAs multiplexed on a same RU or MRU. In some embodiments, when only a single STA is multiplexed on the RU or MRU, the SS allocation subfield includes a number of spatial streams subfield which indicate a number of spatial streams for the STA. In some embodiments, when more than one STA are multiplexed on the RU or MRU, the SS allocation subfield includes a starting spatial stream subfield which indicates a starting spatial stream for the STA and a number of spatial streams subfield which indicates a number of spatial streams for the STA. In some embodiments, each EHT variant user information field includes an AP participation subfield which indicates one or more shared APs that transmit respective PSDUs to a same STA. In some embodiments, a value of 1 in bit position i of the AP participation subfield indicates that a shared AP with AP ID i transmits a physical layer service data unit (PSDU) to the STA; and a value of 0 in bit position i of the AP participation subfield indicates that a shared AP with AP ID i does not transmit a PSDU to the STA. In some embodiments, the one or more shared APs are consecutively numbered in an increasing order of AP ID.

In some embodiments, a number of the one or more APs is up to 3. In some embodiments, each EHT variant user information field includes a per-AP stream configuration subfield which indicates a number of spatial streams transmitted by each of the one or more shared APs to the STA. In some embodiments, a format of the per-AP stream configuration subfield depends on a number of STAs multiplexed on a same RU or MRU. In some embodiments, the per-AP stream configuration subfield is set to a first value to indicate that the shared APs transmit one or more same spatial streams to the STA; and set to a value which is different from a first value to indicate that the shared APs transmit different spatial streams to the STA. In some embodiments, each EHT variant user information field includes a number of per-RU/MRU non-OFDMA users subfield indicates a number of STAs that are multiplexed on a same RU or MRU. In some embodiments, each EHT variant user information field includes a user position subfield indicating a position of the STA addressed by the EHT variant user information field amongst all the STAs that are multiplexed on the same RU or MRU. In some embodiments, EHT variant user information fields addressed to all the STAs multiplexed on the same RU or MRU are placed together in the user information list field of the trigger frame.

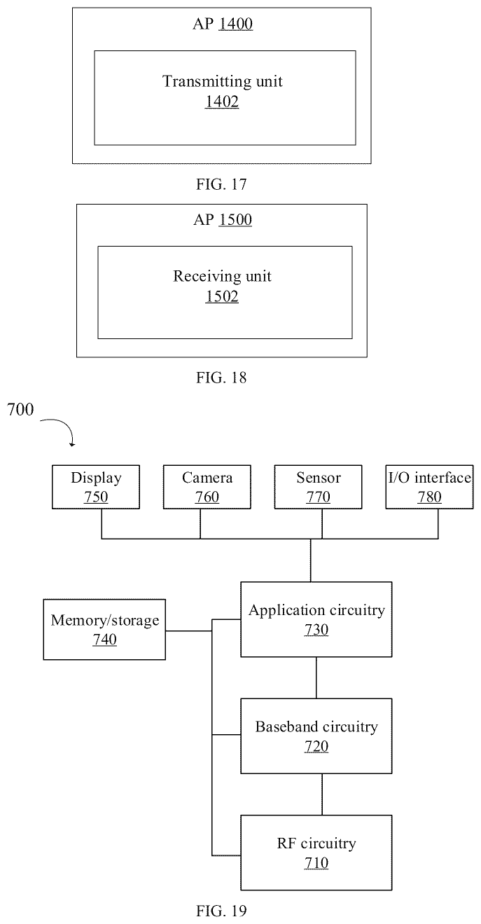

FIG. 17 is a block diagram of an access point (AP) 1400 according to some embodiment of the present disclosure. The access point (AP) 1400 includes a transmitting unit 1402 configured to transmit, to one or more shared APs, a trigger frame to solicit extremely high throughput (EHT) multi-user (MU) physical layer protocol data unit (PPDU) transmissions from the one or more shared APs in a multi-AP coordinated downlink (DL) transmission, wherein the trigger frame includes a EHT variant common information field, a special user information field, and one or more EHT variant user information fields, and a DL bandwidth (BW) subfield of the EHT variant common information field along with a DL BW extension subfield of the special user information field indicates a coordinated transmission BW for the multi-AP coordinated DL transmission. This can solve issues in the prior art, efficiently implement multi-AP DL coordination in a multi-AP system, achieve EHT, provide good communication performance, and/or provide high reliability.

FIG. 18 is a block diagram of an AP 1500 according to some embodiment of the present disclosure. The AP 1500 includes a receiving unit 1502 configured to receive, by the AP 1500 as a shared AP, from another AP as a sharing AP, a trigger frame which is used to solicit extremely high throughput (EHT) multi-user (MU) physical layer protocol data unit (PPDU) transmissions from one or more shared APs including the AP in a multi-AP coordinated downlink (DL) transmission, wherein the trigger frame includes a EHT variant common information field, a special user information field, and one or more EHT variant user information fields, and a DL bandwidth (BW) subfield of the EHT variant common information field along with a DL BW extension subfield of the special user information field indicates a coordinated transmission BW for the multi-AP coordinated DL transmission. This can solve issues in the prior art, efficiently implement multi-AP DL coordination in a multi-AP system, achieve EHT, provide good communication performance, and/or provide high reliability.

Commercial interests for some embodiments are as follows. 1. Solving issues in the prior art. 2. Efficiently implementing multi-AP downlink (DL) coordination in a multi-AP system. 3. Achieving extremely high throughput. 4. Providing a good communication performance. 5. Providing a high reliability. 6. Some embodiments of the present disclosure are used by chipset vendors, communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in communication specification and/or communication standards such as IEEE specification and/or to standards create an end product. Some embodiments of the present disclosure propose technical mechanisms.

FIG. 19 is a block diagram of an example system 700 for wireless communication according to some embodiment of the present disclosure. Embodiments described herein may be implemented into the system using any suitably configured hardware and/or software. FIG. 19 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the AP or STA may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms. The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method by an access point (AP), comprising:
transmitting, by the AP as a sharing AP to one or more shared APs, a trigger frame to solicit extremely high throughput (EHT) multi-user (MU) physical layer protocol data unit (PPDU) transmissions from the one or more shared APs in a multi-AP coordinated downlink (DL) transmission;
wherein the trigger frame comprises a EHT variant common information field, a special user information field, and one or more EHT variant user information fields; and
wherein a DL bandwidth (BW) subfield of the EHT variant common information field along with a DL BW extension subfield of the special user information field indicates a coordinated transmission BW for the multi-AP coordinated DL transmission.

2. The wireless communication method according to claim 1, wherein a TA field of the trigger frame is set to a virtual basic service set identifier (VBSSID) of a VBSS related to the multi-AP coordinated DL transmission.

3. The wireless communication method according to claim 1, wherein if the one or more shared APs comprises a single AP, an RA field of the trigger frame is set to a BSS identifier (BSSID) of the AP; or otherwise, the RA field of the trigger frame is set to a broadcast address.

4. The wireless communication method according to claim 1, wherein the EHT variant common information field comprises a DL length subfield which indicates a value of a non-HT signal field (L-SIG) length field of solicited EHT MU PPDUs.

5. The wireless communication method according to claim 1, wherein the EHT variant common information field comprises a CS required subfield which indicates whether the one or more shared APs are required to use an energy detect (ED) to sense a medium and to consider a medium state and a network allocation vector (NAV) in determining whether or not to transmit solicited EHT MU PPDUs.

6. The wireless communication method according to claim 1, wherein the EHT variant common information field comprises a guard interval (GI) and EHT long training field (EHT-LTF) type subfield and a number of EHT-LTF symbols subfield which indicate values of the GI and EHT-LTF type subfield and the number of EHT-LTF symbols subfield of an EHT-SIG field of solicited EHT MU PPDUs, respectively.

7. The wireless communication method according to claim 1, wherein the EHT variant common information field comprises a low density parity code (LDPC) extra symbol segment subfield, a pre-forward error correction (pre-FEC) padding factor subfield and a packet extension field (PE) disambiguity subfield which indicate values of the LDPC extra symbol segment subfield, the pre-FEC padding factor subfield and the PE disambiguity subfield of an EHT-SIG field of solicited EHT MU PPDUs, respectively.

8. The wireless communication method according to claim 1, wherein the special user information field comprises an EHT spatial reuse subfield which carries a value to be included in a spatial reuse subfield of an EHT-SIG field of solicited EHT MU PPDUs.

9. The wireless communication method according to claim 1, wherein the special user information field or the EHT variant common information field comprises a multi-AP coordinated transmission type subfield which indicates a type of the multi-AP coordinated DL transmission.

10. The wireless communication method according to claim 1, wherein the special user information field or the EHT variant common information field comprises a number of EHT-SIG symbols subfield and an EHT-SIG MCS subfield which indicate values of the number of EHT-SIG symbols subfield and the EHT-SIG modulation and coding scheme (MCS) subfield of a U-SIG field of solicited EHT MU PPDUs, respectively.

11. The wireless communication method according to claim 1, wherein each EHT variant user information field comprises a per-resource unit (RU)/multiple resource unit (MRU) multi-AP coordinated transmission flag subfield which indicates whether multiple APs transmit respective EHT MU PPDUs on a same RU or MRU; and a VAID12 subfield which indicates a STA whose VAID equal to a value of the VAID12 subfield.

12. The wireless communication method according to claim 1, wherein each EHT variant user information field comprises a VAID12 subfield which indicates whether multiple APs transmit respective EHT MU PPDUs on a same RU or MRU.

13. The wireless communication method according to claim 12, wherein the VAID12 subfield is set to a first value in [1 2006] to indicate that only a single AP transmits an EHT MU PPDU on the RU or MRU; and set to a value in [1 2006] which is not equal to a first value to indicate multiple APs transmit respective EHT MU PPDUs on the RU or MRU and indicate a STA whose VAID equal to the value of the VAID12 subfield.

14. An access point (AP), comprising:
a memory;
a transceiver; and
a processor coupled to the memory and the transceiver;
wherein the processor is configured to:
transmit, to one or more shared APs, a trigger frame to solicit extremely high throughput (EHT) multi-user (MU) physical layer protocol data unit (PPDU) transmissions from the one or more shared APs in a multi-AP coordinated downlink (DL) transmission;
wherein the trigger frame comprises a EHT variant common information field, a special user information field, and one or more EHT variant user information fields; and
wherein a DL bandwidth (BW) subfield of the EHT variant common information field along with a DL BW extension subfield of the special user information field indicates a coordinated transmission BW for the multi-AP coordinated DL transmission.

15. The AP according to claim 14, wherein a TA field of the trigger frame is set to a virtual basic service set identifier (VBSSID) of a VBSS related to the multi-AP coordinated DL transmission.

16. The AP according to claim 14, wherein if the one or more shared APs comprises a single AP, an RA field of the trigger frame is set to a BSS identifier (BSSID) of the AP; or otherwise, the RA field of the trigger frame is set to a broadcast address.

17. The AP according to claim 14, wherein each EHT variant user information field comprises a per-resource unit (RU)/multiple resource unit (MRU) multi-AP coordinated transmission flag subfield which indicates whether multiple APs transmit respective EHT MU PPDUs on a same RU or MRU; and a VAID12 subfield which indicates a STA whose VAID equal to a value of the VAID12 subfield.

18. The AP according to claim 14, wherein each EHT variant user information field comprises a VAID12 subfield which indicates whether multiple APs transmit respective EHT MU PPDUs on a same RU or MRU.

19. The AP according to claim 18, wherein the VAID12 subfield is set to a first value in [1 2006] to indicate that only a single AP transmits an EHT MU PPDU on the RU or MRU; and set to a value in [1 2006] which is not equal to a first value to indicate multiple APs transmit respective EHT MU PPDUs on the RU or MRU and indicate a STA whose VAID equal to the value of the VAID12 subfield.

20. An access point (AP), comprising:
a memory;
a transceiver; and
a processor coupled to the memory and the transceiver;
wherein the processor is configured to:
receive, by the AP as a shared AP, from another AP as a sharing AP, a trigger frame which is used to solicit extremely high throughput (EHT) multi-user (MU) physical layer protocol data unit (PPDU) transmissions from one or more shared APs including the AP in a multi-AP coordinated downlink (DL) transmission;
wherein the trigger frame comprises a EHT variant common information field, a special user information field, and one or more EHT variant user information fields;
wherein and a DL bandwidth (BW) subfield of the EHT variant common information field along with a DL BW extension subfield of the special user information field indicates a coordinated transmission BW for the multi-AP coordinated DL transmission.
